(19) United States
(12) Patent Application Publication
(10) Pub. No.: US 2021/0344468 A1
(43) Pub. Date: Nov. 4, 2021

(54) Additional DMRS for NR PDSCH Considering LTE-NR DL Sharing

(71) Applicant: Appe Inc., Cuperino, CA (US)

(72) Inventors: Debdeep Chatterjee, San Jose, CA (US); Alexei Davydov, Nizhny (RU); Seung Hee Han, San Jose, CA (US); Avik Sengupta, San Jose, CA (US)

(21) Appl. No.: 17/282,663

(22) PCT Filed: Oct. 4, 2019
(86) PCT No.: PCT/US2019/054604

§ 371 Date: Apr. 2, 2021

Related U.S. Application Data
(60) Provisional application No. 62/742,129, filed on Oct. 5, 2018.

(51) Int. Cl. H04L 5/00; H04W 72/12

(52) U.S. Cl. CPC H04L 5/0048; H04W 72/1273

(57) ABSTRACT

A mobile radio communication terminal device operable for facilitating a physical downlink shared channel demodulation reference signal of a first mobile radio communication network communication connection during coinciding communications of the first mobile radio communication network and a second mobile radio communication network is provided. The second mobile radio communication network is configured to transmit a cell-specific reference signal. The mobile radio communication terminal device includes one or more processors configured to generate a request for generating a demodulation reference signal to be transmitted from the first mobile radio communication network according to an amended scheduling being shifted with respect to the scheduling of the cell-specific reference signal; and a memory storing the physical downlink shared channel demodulation reference signal of the first mobile radio communication network.

### CROSS-REFERENCE TO RELATED APPLICATIONS

This application is a national phase entry of PCT application number PCT/US2019/054604, entitled “Additional DMRS for NR PDSCH Considering LTE-NR DL Sharing,” filed Oct. 4, 2019, which claims the benefit of priority to Provisional Patent Application No. 62/742,129, entitled “Additional DMRS for NR PDSCH Considering LTE-NR DL Sharing,” filed Oct. 5, 2018 which is hereby incorporated by reference in its entirety as though fully and completely set forth herein. The claims in the instant application are different than those of the parent application or other related applications. The Applicant therefore rescinds any disclaimer of claim scope made in the parent application or any predecessor application in relation to the instant application. The Examiner is therefore advised that any such previous disclaimer and the cited references that it was made to avoid, may need to be revisited. Further, any disclaimer made in the instant application should not be read into or against the parent application or other related applications.

### FIELD

Various aspects relate generally relate to the field of wireless communications.

### BACKGROUND

Numerous DMRS (Demodulation Reference Signal) configurations are supported for PDSCH (Physical Downlink Shared Channel) in NR (New Radio) systems catering to different use cases and link conditions/deployment scenarios, etc. These range from single-symbol “front-loaded-only” DMRS (wherein the PDSCH DMRS occurs relatively early within the PDSCH duration) to multi-symbol DMRS with or without additional occurrences of DMRS within the scheduled PDSCH. It is also expected that NR systems are likely to be deployed in LTE (Long Term Evolution) bands and may co-exist with LTE as a form of shared DL (Downlink) resources between LTE and NR. In such scenarios using “DL sharing”, NR is expected to be deployed with same subcarrier spacing (SCS) for DL operation as for LTE DL, viz., SCS of 15 kHz.

It has been identified that for some DMRS configurations for NR PDSCH, the additional DMRS position may coincide with an LTE symbol carrying LTE Cell-specific Reference Signals (CRS). One such example is the case when additional DMRS is configured for a PDSCH with mapping type A of length 14 symbols and one additional single-symbol DMRS, the additional DMRS symbol is currently specified as being mapped to symbol #11 of an NR slot, which collides with a symbol carrying LTE CRS. This impacts the ability to realize DL resource sharing between NR and LTE in the same carrier in an efficient manner as it implies restriction to either PDSCH scheduling (adversely impacting achievable peak throughput performance), or configuration of additional DMRS (that could impact link performance in cases of high mobility), etc.

Towards this, it has been proposed that, for PDSCH mapping type A with duration of 13 or 14 symbols (from slot boundary to last PDSCH symbol) and dmrs-AdditionalPosition=‘pos1’, the additional DMRS position is shifted to symbol #12 of an NR slot so as to avoid such collisions between LTE CRS and NR DMRS transmissions for the case of unicast PDSCH transmissions when the NR UE (User Equipment) is configured to operate in a 15 kHz DL BWP (Bandwidth Part) and configured to rate match PDSCH around LTE CRS as indicated by the higher layer parameter lte-CRS-ToMatchAround.

However, such shifting of the last DMRS implies that the UE may need to wait until the reception of the last DMRS symbol before performing channel estimation and demodulation for PDSCH reception, thereby reducing the effective available minimum PDSCH processing time (for corresponding HARQ (Hybrid ARQ, Hybrid Automatic Repeat Request)-ACK (Acknowledgement) transmission) in such cases by one OFDM (Orthogonal Frequency Division Multiplexing) symbol.

### BRIEF DESCRIPTION OF THE DRAWINGS

In the drawings, like reference characters generally refer to the same parts throughout the different views. The drawings are not necessarily to scale, emphasis instead generally being placed upon illustrating the principles of the invention. In the following description, various aspects of the invention are described with reference to the following drawings, in which:

FIG. 1 illustrates an architecture of a system of a network in accordance with various aspects;

FIG. 2 illustrates an example architecture of a system in accordance with various aspects

FIG. 3 illustrates an example of infrastructure equipment in accordance with various aspects.

FIG. 4 illustrates an example of a platform (or “device”) in accordance with various aspects.

FIG. 5 illustrates example components of baseband circuitry and radio front end modules (RFEM) in accordance with various aspects.

FIG. 6 is a block diagram illustrating components, according to some example aspects, able to read instructions from a machine-readable or computer-readable medium and perform any one or more of the methodologies discussed herein.

FIG. 7A-D are flowcharts of methods according to various aspects.

### DESCRIPTION

The following detailed description refers to the accompanying drawings that show, by way of illustration, specific details and aspects in which the invention may be practiced.

The word “exemplary” is used herein to mean “serving as an example, instance, or illustration”. Any aspect or design described herein as “exemplary” is not necessarily to be construed as preferred or advantageous over other aspects or designs.

The present disclosure provides mechanisms to address the above-mentioned impact on UE minimum processing times. In addition, methods, that can serve as alternatives to the option of shifting of the last DMRS symbol as a function of the configuration of the higher layer parameter lte-CRS-ToMatchAround.

### Additional DMRS Positions for PDSCH Mapping Type A

The UE assumes the PDSCH DM-RS (Demodulation Reference Signal) being mapped to physical resources according to configuration type 1 or configuration type 2 as given by the higher-layer parameter dmrs-Type. The UE assumes the sequence r(m) is scaled by a factor β_{PDSCH}^{DMRS} to conform with the transmission power specified in 3GPP (Third Generation Partnership Project) TS 38.214 V15.3.0 (2018-09) and mapped to resource elements (k,l)_{p,μ} according to

$${a}_{k . l}^{( p , μ )} = {β}_{P D S C H}^{D M R S} {w}_{f} ( {k}^{′} ) {w}_{t} ( {l}^{′} ) r ( 2 n + {k}^{′} )$$

$$k = \{ \begin{matrix}4 n + 2 {k}^{′} + Δ & Configuration type 1 \\ 6 n + {k}^{′} + Δ & Configuration type 2\end{matrix} \\ {k}^{′} = 0 , 1 \\ l = \overline{l} + {l}^{′} \\ n = 0 , 1 , . . .$$

where wₜ(k′), wₜ(l′), and Δ are given by Tables 7.4.1.1.2-1 and 7.4.1.1.2-2 and the following conditions are fulfilled:
the resource elements are within the common resource blocks allocated for PDSCH transmission
   The reference point for k is
subcarrier 0 of the lowest-numbered resource block in CORESET (Control Resource Set) 0 if the corresponding PDCCH (Physical Downlink Control Channel) is associated with CORESET 0 and Type0-PDCCH common search space and is addressed to SI-RNTI (System Information-Radio Network Temporary Identifier);
otherwise, subcarrier 0 in common resource block 0
   The reference point for l and the position l₀ of the first DM-RS symbol depends on the mapping type:
for PDSCH mapping type A:
   l is defined relative to the start of the slot
   l₀=3 if the higher-layer parameter dmrs-TypeA-Position is equal to ‘pos3’ and l₀=2 otherwise
for PDSCH mapping type B:
   l is defined relative to the start of the scheduled PDSCH resources
   l₀=0
      The position(s) of the DM-RS symbols is given by l̅ and
for PDSCH mapping type A, the duration is between the first OFDM symbol of the slot and the last OFDM symbol of the scheduled PDSCH resources in the slot
for PDSCH mapping type B, the duration is the number of OFDM symbols of the scheduled PDSCH resources as signalled
   and according to Tables 7.4.1.1.2-3 and 7.4.1.1.2-4. The case dmrs-AdditionalPosition equals to ‘pos3’ is only supported when dmrs-TypeA-Position is equal to ‘pos2’. For PDSCH mapping type A, duration of 3 and 4 symbols in Tables 7.4.1.1.2-3 and 7.4.1.1.2-4 respectively is only applicable when dmrs-TypeA-Position is equal to ‘pos2’.

The PDSCH DMRS positions for PDSCH mapping type A are as shown by Table 7.4.1.1.2-3:

TABLE 7.4.1.1.2-1
Parameters for PDSCH DM-RS configuration type 1.

| | CDM (Content | | | | | |
|---|---|---|---|---|---|---|
| | Delivery | | | | | |
| | Network) | | w_{f} (k′) | | wₜ (l′) | |
| p | group^{λ} | Δ | k′ = 0 | k′ = 1 | l′ = 0 | l′ = 1 |
| 1000 | 0 | 0 | +1 | +1 | +1 | +1 |
| 1001 | 0 | 0 | +1 | −1 | +1 | +1 |
| 1002 | 1 | 1 | +1 | +1 | +1 | +1 |
| 1003 | 1 | 1 | +1 | −1 | +1 | +1 |
| 1004 | 0 | 0 | +1 | +1 | +1 | −1 |
| 1005 | 0 | 0 | +1 | −1 | +1 | −1 |
| 1006 | 1 | 1 | +1 | +1 | +1 | −1 |
| 1007 | 1 | 1 | +1 | −1 | +1 | −1 |

TABLE 7.4.1.1.2-2
Parameters for PDSCH DM-RS configuration type 2.

| | CDM | | w_{f} (k′) | | wₜ (l′) | |
|---|---|---|---|---|---|---|
| p | group^{λ} | Δ | k′ = 0 | k′ = 1 | l′ = 0 | l′ = 1 |
| 1000 | 0 | 0 | +1 | +1 | +1 | +1 |
| 1001 | 0 | 0 | +1 | −1 | +1 | +1 |
| 1002 | 1 | 2 | +1 | +1 | +1 | +1 |
| 1003 | 1 | 2 | +1 | −1 | +1 | +1 |
| 1004 | 2 | 4 | +1 | +1 | +1 | +1 |
| 1005 | 2 | 4 | +1 | −1 | +1 | +1 |
| 1006 | 0 | 0 | +1 | +1 | +1 | −1 |
| 1007 | 0 | 0 | +1 | −1 | +1 | −1 |
| 1008 | 1 | 2 | +1 | +1 | +1 | −1 |
| 1009 | 1 | 2 | +1 | −1 | +1 | −1 |
| 1010 | 2 | 4 | +1 | +1 | +1 | −1 |
| 1011 | 2 | 4 | +1 | −1 | +1 | −1 |

TABLE 7.4.1.1.2-3
PDSCH DM-RS positions l̅ for single-symbol DM-RS.

| | DM-RS positions l̅ | | | | | | | |
|---|---|---|---|---|---|---|---|---|
| Dura- | | | | | PDSCH mapping | | | |
| tion | PDSCH mapping type A | | | | type B dmrs- | | | |
| in | dmrs-AdditionalPosition | | | | AdditionalPosition | | | |
| symbols | 0 | 1 | 2 | 3 | 0 | 1 | 2 | 3 |
| 2 | — | — | — | — | l₀ | l₀ | | |
| 3 | l₀ | l₀ | l₀ | l₀ | — | — | | |
| 4 | l₀ | l₀ | l₀ | l₀ | l₀ | l₀ | | |
| 5 | l₀ | l₀ | l₀ | l₀ | — | — | | |
| 6 | l₀ | l₀ | l₀ | l₀ | l₀ | l₀, 4 | | |
| 7 | l₀ | l₀ | l₀ | l₀ | l₀ | l₀, 4 | | |
| 8 | l₀ | l₀, 7 | l₀, 7 | l₀, 7 | — | — | | |
| 9 | l₀ | l₀, 7 | l₀, 7 | l₀, 7 | — | — | | |
| 10 | l₀ | l₀, 9 | l₀, 6, 9 | l₀, 6, 9 | — | — | | |
| 11 | l₀ | l₀, 9 | l₀, 6, 9 | l₀, 6, 9 | — | — | | |
| 12 | l₀ | l₀, 9 | l₀, 6, 9 | l₀, 5, 8, 11 | — | — | | |
| 13 | l₀ | l₀, 11 | l₀, 7, 11 | l₀, 5, 8, 11 | — | — | | |
| 14 | l₀ | l₀, 11 | l₀, 7, 11 | l₀, 5, 8, 11 | — | — | | |

TABLE 7.4.1.1.2-4
PDSCH DM-RS positions l̅ for double-symbol DM-RS.

| | DM-RS positions l̅ | | | | | |
|---|---|---|---|---|---|---|
| | PDSCH mapping type A | | | PDSCH mapping type B | | |
| Duration in | dmrs-AdditionalPosition | | | dmrs-AdditionalPosition | | |
| symbols | 0 | 1 | 2 | 0 | 1 | 2 |
| <4 | | | | — | — | |
| 4 | l₀ | l₀ | | — | — | |
| 5 | l₀ | l₀ | | — | — | |
| 6 | l₀ | l₀ | | l₀ | l₀ | |
| 7 | l₀ | l₀ | | l₀ | l₀ | |
| 8 | l₀ | l₀ | | — | — | |
| 9 | l₀ | l₀ | | — | — | |
| 10 | l₀ | l₀, 8 | | — | — | |
| 11 | l₀ | l₀, 8 | | — | — | |
| 12 | l₀ | l₀, 8 | | — | — | |
| 13 | l₀ | l₀, 10 | | — | — | |
| 14 | l₀ | l₀, 10 | | — | — | |

Note that in the above-quoted tables, the column “Duration in symbols” (D) indicate the number of symbols from the slot boundary (symbol #0) to the last PDSCH symbol for a particular PDSCH allocation with mapping type A.

It can be seen that there are multiple cases possible wherein the NR PDSCH DMRS may collide with LTE CRS transmissions in a symbol. While not limiting the ideas in this disclosure in terms of their applicability to other cases, the cases involving “full-slot” or “almost-full-slot” PDSCH allocations (bold and underlined in the above tables) are prioritized for the purpose of exposition since other cases with shorter PDSCH allocations may be addressed via other scheduling alternatives, while the “full-slot” or “almost-full-slot” PDSCH allocations are significant in terms of realizing achievable peak throughput performances.

In one aspect, the DMRS positions for single-symbol DMRS for D=13, 14 for PDSCH mapping type A are defined such that the last single-symbol DMRS within the PDSCH is in symbol #12 of the slot when the UE is configured with dmrs-AdditionalPosition=‘pos1’, or dmrs-AdditionalPosition=‘pos2’, or dmrs-AdditionalPosition=‘pos3’.

Further, in another aspect, the DMRS positions for single-symbol DMRS for D=13, 14 for PDSCH mapping type A are defined such that, when the UE is configured with dmrs-AdditionalPosition=‘pos2’, the first additional single-symbol DMRS position can be in symbol #8 of the slot.

In a further example, either of the above aspects may apply irrespective of the UE being configured with lte-CRS-ToMatchAround via higher layers. In this case, the new DMRS positions for additional DMRS symbols as in the above aspects may apply to both unicast and broadcast PDSCH.

Alternatively, the mapping to symbol #12 or #8 (for the above two aspects respectively) apply only when the UE is configured with lte-CRS-ToMatchAround via higher layers. In this case, the above aspects may apply only to unicast PDSCH, i.e., PDSCH scheduled using PDCCH with CRC (Cyclic Redundancy Check) scrambled with C-RNTI (Cell Radio Network Temporary Identity (Cell RNTI)), CS (Circuit Switched)-RNTI, or MCS (Modulation and coding scheme)-C-RNTI.

In addition or as alternative to the above dependency on lte-CRS-ToMatchAround via higher layers, in an aspect, the above additional DMRS positions are defined when PDSCH SCS is 15 kHz. Alternatively, in addition or as alternative to the above dependency on lte-CRS-ToMatchAround via higher layers, in an aspect, the above additional DMRS positions are defined for all SCS for the DL BWP in which the PDSCH is scheduled (in turn, implying the PDSCH SCS).

The above two aspects are summarized in Table 1 below, where the values changed compared to existing specifications are marked in red.

TABLE 1
PDSCH DMRS for PDSCH
mapping type A

| Duration | DM-RS positions l̅ | | | |
|---|---|---|---|---|
| in | PDSCH mapping type A | | | |
| symbols | 0 | 1 | 2 | 3 |
| 13 | l₀ | l₀, 12 | l₀, 8, 12 | l₀, 5, 8, 12 |
| 14 | l₀ | l₀, 12 | l₀, 8, 12 | l₀, 5, 8, 12 |

For the case of double-symbol DMRS, in an aspect, the DMRS positions are defined as (l₀, 12) for dmrs-AdditionalPosition=‘pos1’ when the PDSCH is such that D=14. For other cases of D values, the existing values in Table 7.4.1.1.2-4 of TS 38.211 v15.3.0 (2018-09) are used.

### Adjustment of UE Minimum Processing Times in Case of Shifting of Additional DMRS Position

To address the impact on UE minimum processing time for PDSCH processing due to the shift of the last DMRS symbol within the PDSCH duration, in an aspect, the minimum UE processing time value (N1) (in OFDM symbols) is increased by one symbol when the last single-symbol DMRS location within the PDSCH is symbol #12 of the slot for PDSCH mapping type A in case the UE is configured with dmrs-AdditionalPosition pos0 in DMRS-DownlinkConfig in either of dmrs-DownlinkForPDSCHMappingTypeA, dmrsDownlinkForPDSCH-MappingTypeB or if the high layer parameter is not configured.

Alternatively, the minimum UE processing time value (N1) (in OFDM symbols) is increased by one symbol when the second DMRS location is symbol #12 of the slot for PDSCH mapping type A in case the UE is configured with dmrs-AdditionalPosition=pos1 in DMRS-DownhnkConfig in dmrs-DownlinkForPDSCHMappingTypeA.

In a further example, the additional one symbol margin may apply when the SCS of the scheduled PDSCH is 15 kHz. That is, the additional one symbol margin is applicable when μ=0 to determine the minimum PDSCH processing time as in Table 5.3-1 of TS 38.214 v15.3.0 (2018-09).

For the case of double-symbol DMRS, in an aspect, the minimum UE processing time value (N1) (in OFDM symbols) is increased by two symbols when the last double-symbol DMRS location within the PDSCH is symbol #12 of the slot for PDSCH mapping type A in case the UE is configured with dmrs-AdditionalPosition≠pos0 in DMRS-DownhnkConfig in either of dmrs-DownlinkForPDSCHMappingTypeA, dmrsDownhnkForPDSCH-MappingTypeB or if the high layer parameter is not configured.

Alternatively, the minimum UE processing time value (N1) (in OFDM symbols) is increased by two symbols when the last double-symbol DMRS location within the PDSCH is symbol #12 of the slot for PDSCH mapping type A in case the UE is configured with dmrs-AdditionalPosition=pos1 in DMRS-DownlinkConfig in dmrs-DownlinkForPDSCHMappingTypeA.

Note that the above aspects can be straightforwardly applied to the case wherein PDSCH mapping type A is scheduled with D=8 or D=9 and the corresponding DMRS locations are defined for dmrs-AdditionalPosition=‘pos1’ as (l₀, 8), either irrespective of configuration of higher layer parameter lte-CRS-ToMatchAround or when higher layer parameter lte-CRS-ToMatchAround is configured to the UE.

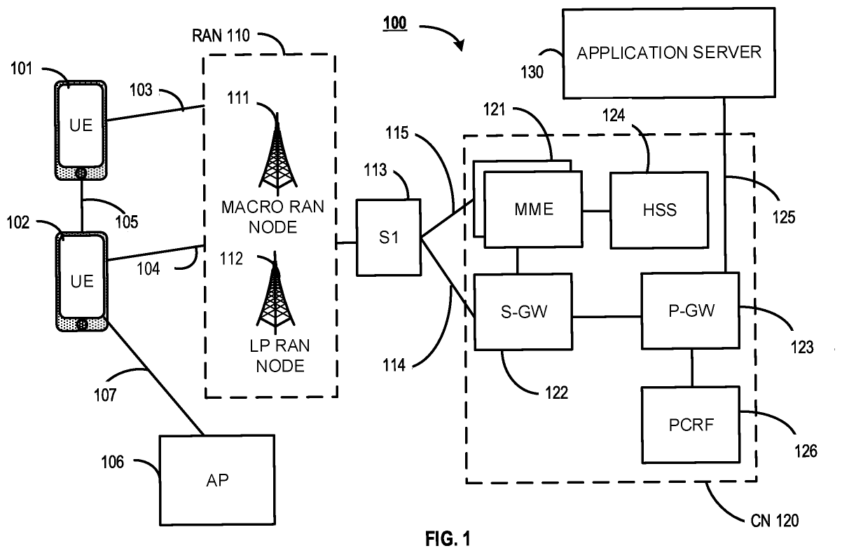

FIG. 1 illustrates an example architecture of a system 100 of a network, in accordance with various embodiments. The following description is provided for an example system 100 that operates in conjunction with the LTE system standards and 5G (Fifth Generation) or NR system standards as provided by 3GPP technical specifications. However, the example embodiments are not limited in this regard and the described embodiments may apply to other networks that benefit from the principles described herein, such as future 3GPP systems (e.g., Sixth Generation (6G)) systems, IEEE (Institute of Electrical and Electronics Engineers) 802.16 protocols (e.g., WMAN, WiMAX (Worldwide Interoperability for Microwave Access), etc.), or the like.

As shown by FIG. 1, the system 100 includes UE 101a and UE 101b (collectively referred to as “UEs 101” or “UE 101”). In this example, UEs 101 are illustrated as smartphones (e.g., handheld touchscreen mobile computing devices connectable to one or more cellular networks), but may also comprise any mobile or non-mobile computing device, such as consumer electronics devices, cellular phones, smartphones, feature phones, tablet computers, wearable computer devices, personal digital assistants (PDAs), pagers, wireless handsets, desktop computers, laptop computers, in-vehicle infotainment (IVI), in-car entertainment (ICE) devices, an Instrument Cluster (IC), head-up display (HUD) devices, onboard diagnostic (OBD) devices, dashtop mobile equipment (DME), mobile data terminals (MDTs), Electronic Engine Management System (EEMS), electronic/engine control units (ECUs), electronic/engine control modules (ECMs), embedded systems, microcontrollers, control modules, engine management systems (EMS), networked or “smart” appliances, MTC (Machine-Type Communications) devices, M2M (Machine-to-Machine), IoT (Internet of Things) devices, and/or the like.

In some embodiments, any of the UEs 101 may be IoT UEs, which may comprise a network access layer designed for low-power IoT applications utilizing short-lived UE connections. An IoT UE can utilize technologies such as M2M or MTC for exchanging data with an MTC server or device via a PLMN (Public Land Mobile Network), ProSe (Proximity Services, Proximity-Based Service) or D2D (device to device) communication, sensor networks, or IoT networks. The M2M or MTC exchange of data may be a machine-initiated exchange of data. An IoT network describes interconnecting IoT UEs, which may include uniquely identifiable embedded computing devices (within the Internet infrastructure), with short-lived connections. The IoT UEs may execute background applications (e.g., keep-alive messages, status updates, etc.) to facilitate the connections of the IoT network.

The UEs 101 may be configured to connect, for example, communicatively couple, with an or RAN (Radio Access Network) 110. In embodiments, the RAN 110 may be an NG (Next Generation, Next Gen) RAN or a 5G RAN, an E-UTRAN (Evolved Universal Terrestrial Radio Access Network), or a legacy RAN, such as a UTRAN or GERAN (GSM (Global System for Mobile Communications, Groupe Spécial Mobile) EDGE RAN, GSM EDGE Radio Access Network). As used herein, the term “NG RAN” or the like may refer to a RAN 110 that operates in an NR or 5G system 100, and the term “E-UTRAN” or the like may refer to a RAN 110 that operates in an LTE or 4G (Fourth Generation) system 100. The UEs 101 utilize connections (or channels) 103 and 104, respectively, each of which comprises a physical communications interface or layer (discussed in further detail below).

In this example, the connections 103 and 104 are illustrated as an air interface to enable communicative coupling, and can be consistent with cellular communications protocols, such as a GSM protocol, a CDMA (Code-Division Multiple Access) network protocol, a PTT (Push-to-Talk) protocol, a POC (PTT over Cellular) protocol, a UMTS (Universal Mobile Telecommunications System) protocol, a 3GPP LTE protocol, a 5G protocol, a NR protocol, and/or any of the other communications protocols discussed herein. In embodiments, the UEs 101 may directly exchange communication data via a ProSe interface 105. The ProSe interface 105 may alternatively be referred to as a SL interface 105 and may comprise one or more logical channels, including but not limited to a PSCCH (Physical Sidelink Control Channel), a PSSCH (Physical Sidelink Shared Channel), a PSDCH (Physical Sidelink Downlink Channel), and a PSBCH (Physical Sidelink Broadcast Channel).

The UE 101b is shown to be configured to access an AP (Application Protocol, Antenna Port, Access Point) 106 (also referred to as “WLAN (Wireless Local Area Network) node 106,” “WLAN 106,” “WLAN Termination 106,” “WT 106” or the like) via connection 107. The connection 107 can comprise a local wireless connection, such as a connection consistent with any IEEE 802.11 protocol, wherein the AP 106 would comprise a wireless fidelity (Wi-Fi®) router. In this example, the AP 106 is shown to be connected to the Internet without connecting to the core network of the wireless system (described in further detail below). In various embodiments, the UE 101b, RAN 110, and AP 106 may be configured to utilize LWA (LTE-WLAN aggregation) operation and/or LWIP (LTE/WLAN Radio Level Integration with IPsec Tunnel) operation. The LWA operation may involve the UE 101b in RRC CONNECTED being configured by a RAN node 111a-b to utilize radio resources of LTE and WLAN. LWIP operation may involve the UE 101b using WLAN radio resources (e.g., connection 107) via IPsec protocol tunneling to authenticate and encrypt packets (e.g., IP (Internet Protocol) packets) sent over the connection 107. IPsec tunneling may include encapsulating the entirety of original IP packets and adding a new packet header, thereby protecting the original header of the IP packets.

The RAN 110 can include one or more AN (Access Network) nodes or RAN nodes 111a and 111b (collectively referred to as “RAN nodes 111” or “RAN node 111”) that enable the connections 103 and 104. As used herein, the terms “access node,” “access point,” or the like may describe equipment that provides the radio baseband functions for data and/or voice connectivity between a network and one or more users. These access nodes can be referred to as BS (Base Station), gNBs (Next Generation NodeB), RAN nodes, eNBs (evolved NodeB, E-UTRAN Node B), NodeBs, RSUs (Road Side Unit), TRxPs or TRPs (Transmission Reception Point), and so forth, and can comprise ground stations (e.g., terrestrial access points) or satellite stations providing coverage within a geographic area (e.g., a cell). As used herein, the term “NG RAN node” or the like may refer to a RAN node 111 that operates in an NR or 5G system 100 (for example, a gNB), and the term “E-UTRAN node” or the like may refer to a RAN node 111 that operates in an LTE or 4G system 100 (e.g., an eNB). According to various embodiments, the RAN nodes 111 may be implemented as one or more of a dedicated physical device such as a macrocell base station, and/or a low power (LP) base station for providing femtocells, picocells or other like cells having smaller coverage areas, smaller user capacity, or higher bandwidth compared to macrocells.

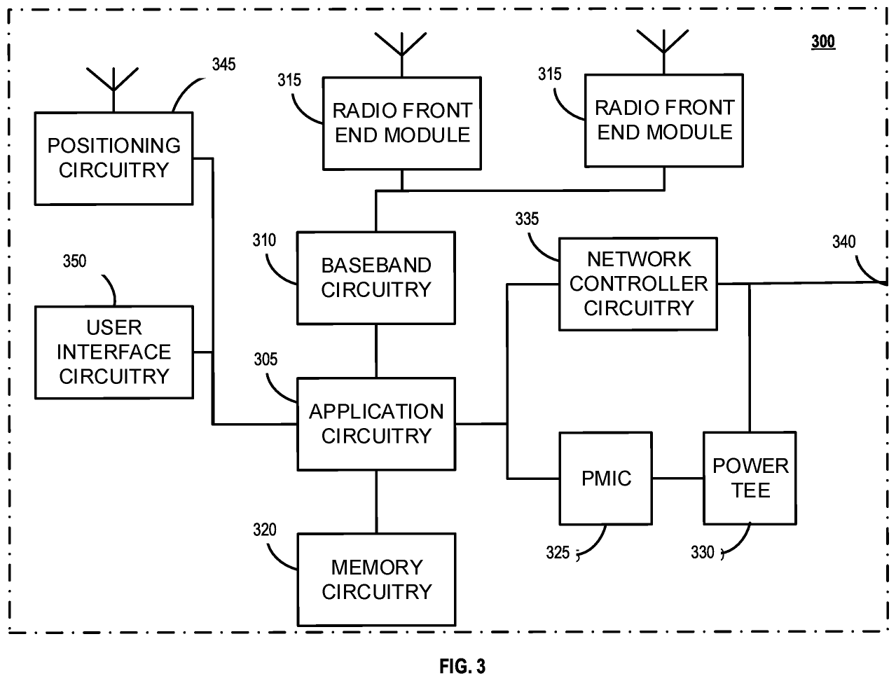

In some embodiments, all or parts of the RAN nodes 111 may be implemented as one or more software entities running on server computers as part of a virtual network, which may be referred to as a CRAN (Cloud Radio Access Network, Cloud RAN) and/or a virtual baseband unit pool (vBBUP). In these embodiments, the CRAN or vBBUP may implement a RAN function split, such as a PDCP (Packet Data Convergence Protocol) split wherein RRC (Radio Resource Control, Radio Resource Control layer) and PDCP layers are operated by the CRAN/vBBUP and other L2 (Layer 2 (data link layer)) protocol entities are operated by individual RAN nodes 111; a MAC/PHY (Physical layer) split wherein RRC, PDCP, RLC (Radio Link Control, Radio Link Control layer), and MAC layers are operated by the CRAN/vBBUP and the PHY layer is operated by individual RAN nodes 111; or a “lower PHY” split wherein RRC, PDCP, RLC, MAC (Medium Access Control (protocol layering context)) layers and upper portions of the PHY layer are operated by the CRAN/vBBUP and lower portions of the PHY layer are operated by individual RAN nodes 111. This virtualized framework allows the freed-up processor cores of the RAN nodes 111 to perform other virtualized applications. In some implementations, an individual RAN node 111 may represent individual gNB-DUs (gNB-distributed unit, Next Generation NodeB distributed unit) that are connected to a gNB-CU (gNB-centralized unit, Next Generation NodeB centralized unit) via individual F1 interfaces (not shown by FIG. 1). In these implementations, the gNB-DUs may include one or more remote radio heads or RFEMs (see, e.g., FIG. 3), and the gNB-CU may be operated by a server that is located in the RAN 110 (not shown) or by a server pool in a similar manner as the CRAN/vBBUP. Additionally or alternatively, one or more of the RAN nodes 111 may be next generation eNBs (ng-eNBs), which are RAN nodes that provide E-UTRA (Evolved UMTS Terrestrial Radio Access) user plane and control plane protocol terminations toward the UEs 101, and are connected to a 5GC (5G Core network) is an NG interface (discussed infra).

In V2X (Vehicle-to-everything) scenarios one or more of the RAN nodes 111 may be or act as RSUs. The term “Road Side Unit” or “RSU” may refer to any transportation infrastructure entity used for V2X communications. An RSU may be implemented in or by a suitable RAN node or a stationary (or relatively stationary) UE, where an RSU implemented in or by a UE may be referred to as a “UE-type RSU,” an RSU implemented in or by an eNB may be referred to as an “eNB-type RSU,” an RSU implemented in or by a gNB may be referred to as a “gNB-type RSU,” and the like. In one example, an RSU is a computing device coupled with radio frequency circuitry located on a roadside that provides connectivity support to passing vehicle UEs 101 (vUEs 101). The RSU may also include internal data storage circuitry to store intersection map geometry, traffic statistics, media, as well as applications/software to sense and control ongoing vehicular and pedestrian traffic. The RSU may operate on the 5.9 GHz Direct Short Range Communications (DSRC) band to provide very low latency communications required for high speed events, such as crash avoidance, traffic warnings, and the like. Additionally or alternatively, the RSU may operate on the cellular V2X band to provide the aforementioned low latency communications, as well as other cellular communications services. Additionally or alternatively, the RSU may operate as a Wi-Fi hotspot (2.4 GHz band) and/or provide connectivity to one or more cellular networks to provide uplink and downlink communications. The computing device(s) and some or all of the radiofrequency circuitry of the RSU may be packaged in a weatherproof enclosure suitable for outdoor installation, and may include a network interface controller to provide a wired connection (e.g., Ethernet) to a traffic signal controller and/or a backhaul network.

Any of the RAN nodes 111 can terminate the air interface protocol and can be the first point of contact for the UEs 101. In some embodiments, any of the RAN nodes 111 can fulfill various logical functions for the RAN 110 including, but not limited to, radio network controller (RNC) functions such as radio bearer management, uplink and downlink dynamic radio resource management and data packet scheduling, and mobility management.

In embodiments, the UEs 101 can be configured to communicate using OFDM communication signals with each other or with any of the RAN nodes 111 over a multicarrier communication channel in accordance with various communication techniques, such as, but not limited to, an OFDMA (Orthogonal Frequency Division Multiple Access) communication technique (e.g., for downlink communications) or a SC-FDMA (Single Carrier Frequency Division Multiple Access) communication technique (e.g., for uplink and ProSe or sidelink communications), although the scope of the embodiments is not limited in this respect. The OFDM signals can comprise a plurality of orthogonal subcarriers.

In some embodiments, a downlink resource grid can be used for downlink transmissions from any of the RAN nodes 111 to the UEs 101, while uplink transmissions can utilize similar techniques. The grid can be a time-frequency grid, called a resource grid or time-frequency resource grid, which is the physical resource in the downlink in each slot. Such a time-frequency plane representation is a common practice for OFDM systems, which makes it intuitive for radio resource allocation. Each column and each row of the resource grid corresponds to one OFDM symbol and one OFDM subcarrier, respectively. The duration of the resource grid in the time domain corresponds to one slot in a radio frame. The smallest time-frequency unit in a resource grid is denoted as a resource element. Each resource grid comprises a number of resource blocks, which describe the mapping of certain physical channels to resource elements. Each resource block comprises a collection of resource elements; in the frequency domain, this may represent the smallest quantity of resources that currently can be allocated. There are several different physical downlink channels that are conveyed using such resource blocks.

According to various embodiments, the UEs 101, 102 and the RAN nodes 111, 112 communicate data (for example, transmit and receive) data over a licensed medium (also referred to as the “licensed spectrum” and/or the “licensed band”) and an unlicensed shared medium (also referred to as the “unlicensed spectrum” and/or the “unlicensed band”). The licensed spectrum may include channels that operate in the frequency range of approximately 400 MHz to approximately 3.8 GHz, whereas the unlicensed spectrum may include the 5 GHz band.

To operate in the unlicensed spectrum, the UEs 101, 102 and the RAN nodes 111, 112 may operate using LAA (Licensed Assisted Access), eLAA (enhanced Licensed Assisted Access, enhanced LAA), and/or feLAA (further enhanced Licensed Assisted Access, further enhanced LAA) mechanisms. In these implementations, the UEs 101, 102 and the RAN nodes 111, 112 may perform one or more known medium-sensing operations and/or carrier-sensing operations in order to determine whether one or more channels in the unlicensed spectrum is unavailable or otherwise occupied prior to transmitting in the unlicensed spectrum. The medium/carrier sensing operations may be performed according to a listen-before-talk (LBT) protocol.

LBT is a mechanism whereby equipment (for example, UEs 101, 102, RAN nodes 111, 112, etc.) senses a medium (for example, a channel or carrier frequency) and transmits when the medium is sensed to be idle (or when a specific channel in the medium is sensed to be unoccupied). The medium sensing operation may include CCA (Clear Channel Assessment), which utilizes at least ED (Energy Detection) to determine the presence or absence of other signals on a channel in order to determine if a channel is occupied or clear. This LBT mechanism allows cellular/LAA networks to coexist with incumbent systems in the unlicensed spectrum and with other LAA networks. ED may include sensing RF (Radio Frequency) energy across an intended transmission band for a period of time and comparing the sensed RF energy to a predefined or configured threshold.

Typically, the incumbent systems in the 5 GHz band are WLANs based on IEEE 802.11 technologies. WLAN employs a contention-based channel access mechanism, called CSMA (Carrier Sense Multiple Access)/CA (CSMA with collision avoidance). Here, when a WLAN node (e.g., a mobile station (MS) such as UE 101 or 102, AP 106, or the like) intends to transmit, the WLAN node may first perform CCA before transmission. Additionally, a backoff mechanism is used to avoid collisions in situations where more than one WLAN node senses the channel as idle and transmits at the same time. The backoff mechanism may be a counter that is drawn randomly within the CWS (Contention Window Size), which is increased exponentially upon the occurrence of collision and reset to a minimum value when the transmission succeeds. The LBT mechanism designed for LAA is somewhat similar to the CSMA/CA of WLAN. In some implementations, the LBT procedure for DL or UL (Uplink) transmission bursts including PDSCH or PUSCH (Physical Uplink Shared Channel) transmissions, respectively, may have an LAA contention window that is variable in length between X and Y ECCA (extended clear channel assessment, extended CCA) slots, where X and Y are minimum and maximum values for the CWSs for LAA. In one example, the minimum CWS for an LAA transmission may be 9 microseconds (p); however, the size of the CWS and a MCOT (Maximum Channel Occupancy Time; for example, a transmission burst) may be based on governmental regulatory requirements.

The LAA mechanisms are built upon CA (Carrier Aggregation, Certification Authority) technologies of LTE-Advanced systems. In CA, each aggregated carrier is referred to as a CC (Component Carrier, Country Code, Cryptographic Checksum). A CC may have a bandwidth of 1.4, 3, 5, 10, 15 or 20 MHz and a maximum of five CCs can be aggregated, and therefore, a maximum aggregated bandwidth is 100 MHz. In FDD (Frequency Division Duplex) systems, the number of aggregated carriers can be different for DL and UL, where the number of UL CCs is equal to or lower than the number of DL component carriers. In some cases, individual CCs can have a different bandwidth than other CCs. In TDD (Time Division Duplex) systems, the number of CCs as well as the bandwidths of each CC is usually the same for DL and UL.

CA also comprises individual serving cells to provide individual CCs. The coverage of the serving cells may differ, for example, because CCs on different frequency bands will experience different pathloss. A primary service cell or PCell may provide a PCC (Primary Component Carrier, Primary CC) for both UL and DL, and may handle RRC and NAS (Non-Access Stratum, Non-Access Stratum layer) related activities. The other serving cells are referred to as SCells, and each SCell may provide an individual SCC (Secondary Component Carrier, Secondary CC) for both UL and DL. The SCCs may be added and removed as required, while changing the PCC may require the UE 101, 102 to undergo a handover. In LAA, eLAA, and feLAA, some or all of the SCells (Secondary Cell) may operate in the unlicensed spectrum (referred to as “LAA SCells”), and the LAA SCells are assisted by a PCell (Primary Cell) operating in the licensed spectrum. When a UE is configured with more than one LAA SCell, the UE may receive UL grants on the configured LAA SCells indicating different PUSCH starting positions within a same subframe.

The PDSCH carries user data and higher-layer signaling to the UEs 101. The PDCCH carries information about the transport format and resource allocations related to the PDSCH channel, among other things. It may also inform the UEs 101 about the transport format, resource allocation, and HARQ information related to the uplink shared channel. Typically, downlink scheduling (assigning control and shared channel resource blocks to the UE 101b within a cell) may be performed at any of the RAN nodes 111 based on channel quality information fed back from any of the UEs 101. The downlink resource assignment information may be sent on the PDCCH used for (e.g., assigned to) each of the UEs 101.

The PDCCH uses CCEs (Control Channel Element) to convey the control information. Before being mapped to resource elements, the PDCCH complex-valued symbols may first be organized into quadruplets, which may then be permuted using a sub-block interleaver for rate matching. Each PDCCH may be transmitted using one or more of these CCEs, where each CCE may correspond to nine sets of four physical resource elements known as REGs (Resource Element Group). Four Quadrature Phase Shift Keying (QPSK) symbols may be mapped to each REG. The PDCCH can be transmitted using one or more CCEs, depending on the size of the DCI (Downlink Control Information) and the channel condition. There can be four or more different PDCCH formats defined in LTE with different numbers of CCEs (e.g., aggregation level, L=1, 2, 4, or 8).

Some embodiments may use concepts for resource allocation for control channel information that are an extension of the above-described concepts. For example, some embodiments may utilize an EPDCCH (enhanced PDCCH, enhanced Physical Downlink Control Channel) that uses PDSCH resources for control information transmission. The EPDCCH may be transmitted using one or more ECCEs (Enhanced Control Channel Element, Enhanced CCE). Similar to above, each ECCE may correspond to nine sets of four physical resource elements known as an EREGs (enhanced REG, enhanced resource element groups). An ECCE may have other numbers of EREGs in some situations.

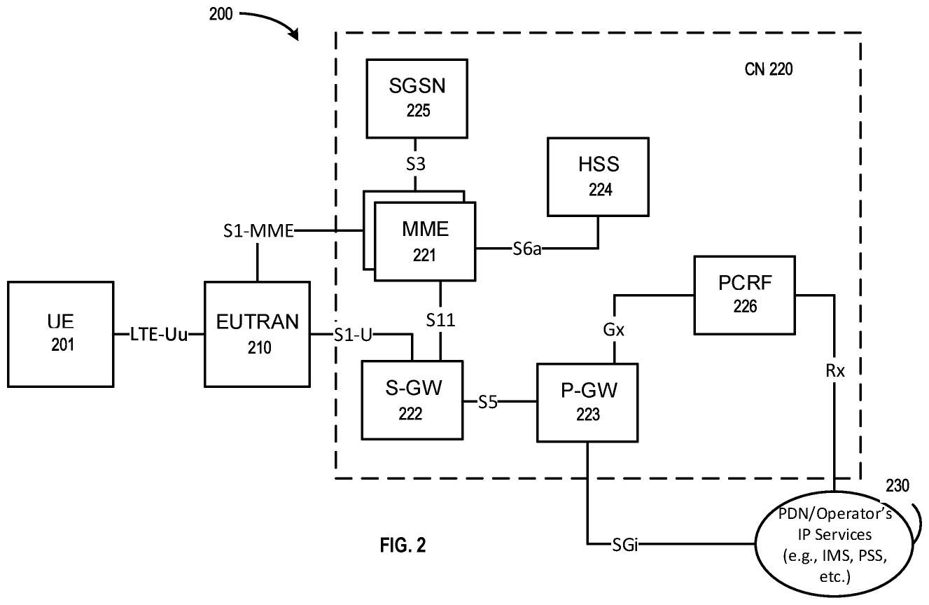

The RAN nodes 111 may be configured to communicate with one another via interface 112. In embodiments where the system 100 is an LTE system (e.g., when CN 120 is an EPC (Evolved Packet Core) 220 as in FIG. 2), the interface 112 may be an X2 interface 112. The X2 interface may be defined between two or more RAN nodes 111 (e.g., two or more eNBs and the like) that connect to EPC 120, and/or between two eNBs connecting to EPC 120. In some implementations, the X2 interface may include an X2 user plane interface (X2-U) and an X2 control plane interface (X2-C). The X2-U may provide flow control mechanisms for user data packets transferred over the X2 interface, and may be used to communicate information about the delivery of user data between eNBs. For example, the X2-U may provide specific sequence number information for user data transferred from a MeNB (master eNB) to an SeNB (secondary eNB); information about successful in sequence delivery of PDCP PDUs (Protocol Data Unit) to a UE 101 from an SeNB for user data; information of PDCP PDUs that were not delivered to a UE 101; information about a current minimum desired buffer size at the SeNB for transmitting to the UE user data; and the like. The X2-C may provide intra-LTE access mobility functionality, including context transfers from source to target eNBs, user plane transport control, etc.; load management functionality; as well as inter-cell interference coordination functionality.

In embodiments where the system 100 is a 5G or NR system (e.g., when CN 120 is an 5GC), the interface 112 may be an Xn interface 112. The Xn interface is defined between two or more RAN nodes 111 (e.g., two or more gNBs and the like) that connect to 5GC 120, between a RAN node 111 (e.g., a gNB) connecting to 5GC 120 and an eNB, and/or between two eNBs connecting to 5GC 120. In some implementations, the Xn interface may include an Xn user plane (Xn-U) interface and an Xn control plane (Xn-C) interface. The Xn-U may provide non-guaranteed delivery of user plane PDUs and support/provide data forwarding and flow control functionality. The Xn-C may provide management and error handling functionality, functionality to manage the Xn-C interface; mobility support for UE 101 in a connected mode (e.g., CM (Connection Management, Conditional Mandatory)-CONNECTED) including functionality to manage the UE mobility for connected mode between one or more RAN nodes 111. The mobility support may include context transfer from an old (source) serving RAN node 111 to new (target) serving RAN node 111; and control of user plane tunnels between old (source) serving RAN node 111 to new (target) serving RAN node 111. A protocol stack of the Xn-U may include a transport network layer built on Internet Protocol (IP) transport layer, and a GTP-U (GPRS Tunneling Protocol for User Plane) layer on top of a UDP (User Datagram Protocol) and/or IP layer(s) to carry user plane PDUs. The Xn-C protocol stack may include an application layer signaling protocol (referred to as Xn Application Protocol (Xn-AP)) and a transport network layer that is built on SCTP (Single Carrier Frequency Division Multiple Access). The SCTP may be on top of an IP layer, and may provide the guaranteed delivery of application layer messages. In the transport IP layer, point-to-point transmission is used to deliver the signaling PDUs. In other implementations, the Xn-U protocol stack and/or the Xn-C protocol stack may be same or similar to the user plane and/or control plane protocol stack(s) shown and described herein.

The RAN 110 is shown to be communicatively coupled to a core network—in this embodiment, core network (CN) 120. The CN 120 may comprise a plurality of network elements 122, which are configured to offer various data and telecommunications services to customers/subscribers (e.g., users of UEs 101) who are connected to the CN 120 via the RAN 110. The components of the CN 120 may be implemented in one physical node or separate physical nodes including components to read and execute instructions from a machine-readable or computer-readable medium (e.g., a non-transitory machine-readable storage medium). In some embodiments, NFV (Network Functions Virtualization) may be utilized to virtualize any or all of the above-described network node functions via executable instructions stored in one or more computer-readable storage mediums (described in further detail below). A logical instantiation of the CN 120 may be referred to as a network slice, and a logical instantiation of a portion of the CN 120 may be referred to as a network sub-slice. NFV architectures and infrastructures may be used to virtualize one or more network functions, alternatively performed by proprietary hardware, onto physical resources comprising a combination of industry-standard server hardware, storage hardware, or switches. In other words, NFV systems can be used to execute virtual or reconfigurable implementations of one or more EPC components/functions.

Generally, the application server 130 may be an element offering applications that use IP bearer resources with the core network (e.g., UMTS PS (Packet Services) domain, LTE PS data services, etc.). The application server 130 can also be configured to support one or more communication services (e.g., VoIP (Voice-over-IP, Voice-over-Internet Protocol) sessions, PTT sessions, group communication sessions, social networking services, etc.) for the UEs 101 via the EPC 120.

In embodiments, the CN 120 may be a 5GC (referred to as “5GC 120” or the like), and the RAN 110 may be connected with the CN 120 via an NG interface 113. In embodiments, the NG interface 113 may be split into two parts, an NG user plane (NG-U) interface 114, which carries traffic data between the RAN nodes 111 and a UPF (User Plane Function), and the S1 control plane (NG-C) interface 115, which is a signaling interface between the RAN nodes 111 and AMFs (Access and Mobility Management Function).

In embodiments, the CN 120 may be a 5G CN (referred to as “5GC 120” or the like), while in other embodiments, the CN 120 may be an EPC). Where CN 120 is an EPC (referred to as “EPC 120” or the like), the RAN 110 may be connected with the CN 120 via an S1 interface 113. In embodiments, the S1 interface 113 may be split into two parts, an S1 user plane (S1-U) interface 114, which carries traffic data between the RAN nodes 111 and the S-GW (Serving Gateway), and the S1-MME (S1 for the control plane—Mobility Management Entity) interface 115, which is a signaling interface between the RAN nodes 111 and MMES. An example architecture wherein the CN 120 is an EPC 120 is shown by FIG. 2.

FIG. 2 illustrates an example architecture of a system 200 including a first CN 220, in accordance with various embodiments. In this example, system 200 may implement the LTE standard wherein the CN 220 is an EPC 220 that corresponds with CN 120 of FIG. 1. Additionally, the UE 201 may be the same or similar as the UEs 101 of FIG. 1, and the E-UTRAN 210 may be a RAN that is the same or similar to the RAN 110 of FIG. 1, and which may include RAN nodes 111 discussed previously. The CN 220 may comprise MMEs 221, an S-GW 222, a P-GW (PDN Gateway) 223, a HSS (Home Subscriber Server) 224, and a SGSN (Serving GPRS Support Node) 225.

The MMEs 221 may be similar in function to the control plane of legacy SGSN, and may implement MM functions to keep track of the current location of a UE 201. The MMEs 221 may perform various MM procedures to manage mobility aspects in access such as gateway selection and tracking area list management. MM (also referred to as “EPS MM” or “EMM” in E-UTRAN systems) may refer to all applicable procedures, methods, data storage, etc. that are used to maintain knowledge about a present location of the UE 201, provide user identity confidentiality, and/or perform other like services to users/subscribers. Each UE 201 and the MME 221 may include an MM or EMM sublayer, and an MM context may be established in the UE 201 and the MME 221 when an attach procedure is successfully completed. The MM context may be a data structure or database object that stores MM-related information of the UE 201. The MMEs 221 may be coupled with the HSS 224 via an S6a reference point, coupled with the SGSN 225 via an S3 reference point, and coupled with the S-GW (Serving Gateway) 222 via an S11 reference point.

The SGSN 225 may be a node that serves the UE 201 by tracking the location of an individual UE 201 and performing security functions. In addition, the SGSN 225 may perform Inter-EPC node signaling for mobility between 2G/3G and E-UTRAN 3GPP access networks; PDN (Packet Data Network, Public Data Network) and S-GW selection as specified by the MMEs 221; handling of UE 201 time zone functions as specified by the MMEs 221; and MME selection for handovers to E-UTRAN 3GPP access network. The S3 reference point between the MMEs 221 and the SGSN 225 may enable user and bearer information exchange for inter-3GPP access network mobility in idle and/or active states.

The HSS 224 may comprise a database for network users, including subscription-related information to support the network entities' handling of communication sessions. The EPC 220 may comprise one or several HSSs 224, depending on the number of mobile subscribers, on the capacity of the equipment, on the organization of the network, etc. For example, the HSS 224 can provide support for routing/roaming, authentication, authorization, naming/addressing resolution, location dependencies, etc. An S6a reference point between the HSS 224 and the MMEs 221 may enable transfer of subscription and authentication data for authenticating/authorizing user access to the EPC 220 between HSS 224 and the MMEs 221.

The S-GW 222 may terminate the S1 interface 113 (“S1-U” in FIG. 2, S1 for the user plane) toward the RAN 210, and routes data packets between the RAN 210 and the EPC 220. In addition, the S-GW 222 may be a local mobility anchor point for inter-RAN node handovers and also may provide an anchor for inter-3GPP mobility. Other responsibilities may include lawful intercept, charging, and some policy enforcement. The S11 reference point between the S-GW 222 and the MMEs 221 may provide a control plane between the MMEs 221 and the S-GW 222. The S-GW 222 may be coupled with the P-GW 223 via an S5 reference point.

The P-GW 223 may terminate an SGi interface toward a PDN 230. The P-GW 223 may route data packets between the EPC 220 and external networks such as a network including the application server 130 (alternatively referred to as an “AF” (Application Function)) via an IP interface 125 (see e.g., FIG. 1). In embodiments, the P-GW 223 may be communicatively coupled to an application server (application server 130 of FIG. 1 or PDN 230 in FIG. 2) via an IP communications interface 125 (see, e.g., FIG. 1). The S5 reference point between the P-GW 223 and the S-GW 222 may provide user plane tunneling and tunnel management between the P-GW 223 and the S-GW 222. The S5 reference point may also be used for S-GW 222 relocation due to UE 201 mobility and if the S-GW 222 needs to connect to a non-collocated P-GW 223 for the required PDN connectivity. The P-GW 223 may further include a node for policy enforcement and charging data collection (e.g., PCEF (Policy and Charging Enforcement Function) (not shown)). Additionally, the SGi reference point between the P-GW 223 and the packet data network (PDN) 230 may be an operator external public, a private PDN, or an intra operator packet data network, for example, for provision of IMS (IP Multimedia Subsystem) services. The P-GW 223 may be coupled with a PCRF (Policy Control and Charging Rules Function) 226 via a Gx reference point.

PCRF 226 is the policy and charging control element of the EPC 220. In a non-roaming scenario, there may be a single PCRF 226 in the Home Public Land Mobile Network (HPLMN) associated with a UE 201's Internet Protocol Connectivity Access Network (IP-CAN) session. In a roaming scenario with local breakout of traffic, there may be two PCRFs associated with a UE 201's IP-CAN session, a Home PCRF (H-PCRF) within an HPLMN and a Visited PCRF (V-PCRF) within a Visited Public Land Mobile Network (VPLMN). The PCRF 226 may be communicatively coupled to the application server 230 via the P-GW 223. The application server 230 may signal the PCRF 226 to indicate a new service flow and select the appropriate QoS (Quality of Service) and charging parameters. The PCRF 226 may provision this rule into a PCEF (not shown) with the appropriate TFT and QCI, which commences the QoS and charging as specified by the application server 230. The Gx reference point between the PCRF 226 and the P-GW 223 may allow for the transfer of QoS policy and charging rules from the PCRF 226 to PCEF in the P-GW 223. An Rx (Reception, Receiving, Receiver) reference point may reside between the PDN 230 (or “AF 230”) and the PCRF 226.

FIG. 3 illustrates an example of infrastructure equipment 300 in accordance with various embodiments. The infrastructure equipment 300 (or “system 300”) may be implemented as a base station, radio head, RAN node such as the RAN nodes 111 and/or AP 106 shown and described previously, application server(s) 130, and/or any other element/device discussed herein. In other examples, the system 300 could be implemented in or by a UE.

The system 300 includes application circuitry 305, baseband circuitry 310, one or more radio front end modules (RFEMs) 315, memory circuitry 320, power management integrated circuitry (PMIC) 325, power tee circuitry 330, network controller circuitry 335, network interface connector 340, satellite positioning circuitry 345, and user interface 350. In some embodiments, the device 300 may include additional elements such as, for example, memory/storage, display, camera, sensor, or input/output (I/O) interface. In other embodiments, the components described below may be included in more than one device. For example, said circuitries may be separately included in more than one device for CRAN, vBBU, or other like implementations.

Application circuitry 305 includes circuitry such as, but not limited to one or more processors (or processor cores), cache memory, and one or more of low drop-out voltage regulators (LDOs), interrupt controllers, serial interfaces such as SPI, I²C or universal programmable serial interface module, real time clock (RTC), timer-counters including interval and watchdog timers, general purpose input/output (I/O or IO), memory card controllers such as Secure Digital (SD) MultiMediaCard (MMC) or similar, Universal Serial Bus (USB) interfaces, Mobile Industry Processor Interface (MIPI) interfaces and Joint Test Access Group (JTAG) test access ports. The processors (or cores) of the application circuitry 305 may be coupled with or may include memory/storage elements and may be configured to execute instructions stored in the memory/storage to enable various applications or operating systems to run on the system 300. In some implementations, the memory/storage elements may be on-chip memory circuitry, which may include any suitable volatile and/or non-volatile memory, such as DRAM, SRAM, EPROM, EEPROM, Flash memory, solid-state memory, and/or any other type of memory device technology, such as those discussed herein.

The processor(s) of application circuitry 305 may include, for example, one or more processor cores (CPUs (CSI (Channel-State Information) processing unit, Central Processing Unit)), one or more application processors, one or more graphics processing units (GPUs), one or more reduced instruction set computing (RISC) processors, one or more Acorn RISC Machine (ARM) processors, one or more complex instruction set computing (CISC) processors, one or more digital signal processors (DSP), one or more FPGAs (Field-Programmable Gate Array), one or more PLDs, one or more ASICs, one or more microprocessors or controllers, or any suitable combination thereof. In some embodiments, the application circuitry 305 may comprise, or may be, a special-purpose processor/controller to operate according to the various embodiments herein. As examples, the processor(s) of application circuitry 305 may include one or more Intel Pentium®, Core®, or Xeon® processor(s); Advanced Micro Devices (AMD) Ryzen® processor(s), Accelerated Processing Units (APUs), or Epyc® processors; ARM-based processor(s) licensed from ARM Holdings, Ltd. such as the ARM Cortex-A family of processors and the ThunderX2® provided by Cavium™, Inc.; a MIPS-based design from MIPS Technologies, Inc. such as MIPS Warrior P-class processors; and/or the like. In some embodiments, the system 300 may not utilize application circuitry 305, and instead may include a special-purpose processor/controller to process IP data received from an EPC or SGC, for example.

In some implementations, the application circuitry 305 may include one or more hardware accelerators, which may be microprocessors, programmable processing devices, or the like. The one or more hardware accelerators may include, for example, computer vision (CV) and/or deep learning (DL) accelerators. As examples, the programmable processing devices may be one or more a field-programmable devices (FPDs) such as field-programmable gate arrays (FPGAs) and the like; programmable logic devices (PLDs) such as complex PLDs (CPLDs), high-capacity PLDs (HCPLDs), and the like; ASICs such as structured ASICs and the like; programmable SoCs (System on Chip) (PSoCs); and the like. In such implementations, the circuitry of application circuitry 305 may comprise logic blocks or logic fabric, and other interconnected resources that may be programmed to perform various functions, such as the procedures, methods, functions, etc. of the various embodiments discussed herein. In such embodiments, the circuitry of application circuitry 305 may include memory cells (e.g., erasable programmable read-only memory (EPROM), electrically erasable programmable read-only memory (EEPROM), flash memory, static memory (e.g., static random access memory (SRAM), anti-fuses, etc.)) used to store logic blocks, logic fabric, data, etc. in look-up-tables (LUTs) and the like.

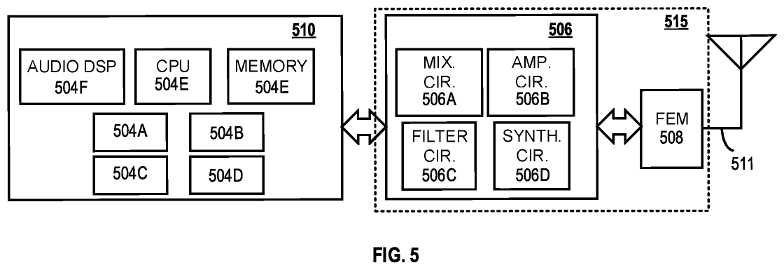

The baseband circuitry 310 may be implemented, for example, as a solder-down substrate including one or more integrated circuits, a single packaged integrated circuit soldered to a main circuit board or a multi-chip module containing two or more integrated circuits. The various hardware electronic elements of baseband circuitry 310 are discussed infra with regard to FIG. 5.

User interface circuitry 350 may include one or more user interfaces designed to enable user interaction with the system 300 or peripheral component interfaces designed to enable peripheral component interaction with the system 300. User interfaces may include, but are not limited to, one or more physical or virtual buttons (e.g., a reset button), one or more indicators (e.g., light emitting diodes (LEDs)), a physical keyboard or keypad, a mouse, a touchpad, a touchscreen, speakers or other audio emitting devices, microphones, a printer, a scanner, a headset, a display screen or display device, etc. Peripheral component interfaces may include, but are not limited to, a nonvolatile memory port, a universal serial bus (USB) port, an audio jack, a power supply interface, etc.

The radio front end modules (RFEMs) 315 may comprise a millimeter wave (mmWave) RFEM and one or more sub-mmWave radio frequency integrated circuits (RFICs). In some implementations, the one or more sub-mmWave RFICs may be physically separated from the mmWave RFEM. The RFICs may include connections to one or more antennas or antenna arrays (see e.g., antenna array 5111 of FIG. 5 infra), and the RFEM may be connected to multiple antennas. In alternative implementations, both mmWave and sub-mmWave radio functions may be implemented in the same physical RFEM 315, which incorporates both mmWave antennas and sub-mmWave.

The memory circuitry 320 may include one or more of volatile memory including dynamic random access memory (DRAM) and/or synchronous dynamic random access memory (SDRAM), and nonvolatile memory (NVM) including high-speed electrically erasable memory (commonly referred to as Flash memory), phase change random access memory (PRAM), magnetoresistive random access memory (MRAM), etc., and may incorporate the three-dimensional (3D) cross-point (XPOINT) memories from Intel® and Micron®. Memory circuitry 320 may be implemented as one or more of solder down packaged integrated circuits, socketed memory modules and plug-in memory cards.

The PMIC 325 may include voltage regulators, surge protectors, power alarm detection circuitry, and one or more backup power sources such as a battery or capacitor. The power alarm detection circuitry may detect one or more of brown out (under-voltage) and surge (over-voltage) conditions. The power tee circuitry 330 may provide for electrical power drawn from a network cable to provide both power supply and data connectivity to the infrastructure equipment 300 using a single cable.

The network controller circuitry 335 may provide connectivity to a network using a standard network interface protocol such as Ethernet, Ethernet over GRE Tunnels, Ethernet over Multiprotocol Label Switching (MPLS), or some other suitable protocol. Network connectivity may be provided to/from the infrastructure equipment 300 via network interface connector 340 using a physical connection, which may be electrical (commonly referred to as a “copper interconnect”), optical, or wireless. The network controller circuitry 335 may include one or more dedicated processors and/or FPGAs to communicate using one or more of the aforementioned protocols. In some implementations, the network controller circuitry 335 may include multiple controllers to provide connectivity to other networks using the same or different protocols.

The positioning circuitry 345 includes circuitry to receive and decode signals transmitted/broadcasted by a positioning network of a global navigation satellite system (GNSS). Examples of navigation satellite constellations (or GNSS) include United States' Global Positioning System (GPS), Russia's Global Navigation System (GLONASS), the European Union's Galileo system, China's BeiDou Navigation Satellite System, a regional navigation system or GNSS augmentation system (e.g., Navigation with Indian Constellation (NAVIC), Japan's Quasi-Zenith Satellite System (QZSS), France's Doppler Orbitography and Radio-positioning Integrated by Satellite (DORIS), etc.), or the like. The positioning circuitry 345 comprises various hardware elements (e.g., including hardware devices such as switches, filters, amplifiers, antenna elements, and the like to facilitate OTA (over-the-air) communications) to communicate with components of a positioning network, such as navigation satellite constellation nodes. In some embodiments, the positioning circuitry 345 may include a Micro-Technology for Positioning, Navigation, and Timing (Micro-PNT) IC that uses a master timing clock to perform position tracking/estimation without GNSS assistance. The positioning circuitry 345 may also be part of, or interact with, the baseband circuitry 310 and/or RFEMs 315 to communicate with the nodes and components of the positioning network. The positioning circuitry 345 may also provide position data and/or time data to the application circuitry 305, which may use the data to synchronize operations with various infrastructure (e.g., RAN nodes 111, etc.), or the like.

The components shown by FIG. 3 may communicate with one another using interface circuitry, which may include any number of bus and/or interconnect (IX) technologies such as industry standard architecture (ISA), extended ISA (EISA), peripheral component interconnect (PCI), peripheral component interconnect extended (PCIx), PCI express (PCIe), or any number of other technologies. The bus/IX may be a proprietary bus, for example, used in a SoC based system. Other bus/IX systems may be included, such as an I²C interface, an SPI interface, point to point interfaces, and a power bus, among others.

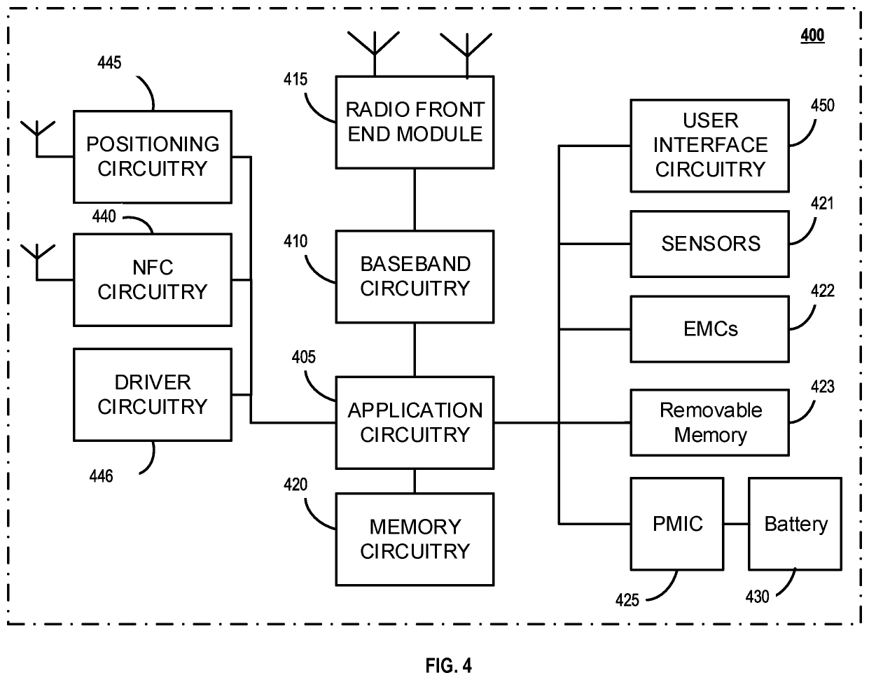

FIG. 4 illustrates an example of a platform 400 (or “device 400”) in accordance with various embodiments. In embodiments, the computer platform 400 may be suitable for use as UEs 101, 102, 201, application servers 130, and/or any other element/device discussed herein. The platform 400 may include any combinations of the components shown in the example. The components of platform 400 may be implemented as integrated circuits (ICs), portions thereof, discrete electronic devices, or other modules, logic, hardware, software, firmware, or a combination thereof adapted in the computer platform 400, or as components otherwise incorporated within a chassis of a larger system. The block diagram of FIG. 4 is intended to show a high level view of components of the computer platform 400. However, some of the components shown may be omitted, additional components may be present, and different arrangement of the components shown may occur in other implementations.

Application circuitry 405 includes circuitry such as, but not limited to one or more processors (or processor cores), cache memory, and one or more of LDOs, interrupt controllers, serial interfaces such as SPI, I²C or universal programmable serial interface module, RTC, timer-counters including interval and watchdog timers, general purpose I/O, memory card controllers such as SD MMC or similar, USB interfaces, MIPI interfaces, and JTAG test access ports. The processors (or cores) of the application circuitry 405 may be coupled with or may include memory/storage elements and may be configured to execute instructions stored in the memory/storage to enable various applications or operating systems to run on the system 400. In some implementations, the memory/storage elements may be on-chip memory circuitry, which may include any suitable volatile and/or non-volatile memory, such as DRAM, SRAM, EPROM, EEPROM, Flash memory, solid-state memory, and/or any other type of memory device technology, such as those discussed herein.

The processor(s) of application circuitry 305 may include, for example, one or more processor cores, one or more application processors, one or more GPUs, one or more RISC processors, one or more ARM processors, one or more CISC processors, one or more DSP, one or more FPGAs, one or more PLDs, one or more ASICs, one or more microprocessors or controllers, a multithreaded processor, an ultra-low voltage processor, an embedded processor, some other known processing element, or any suitable combination thereof. In some embodiments, the application circuitry 305 may comprise, or may be, a special-purpose processor/controller to operate according to the various embodiments herein.

As examples, the processor(s) of application circuitry 405 may include an Intel® Architecture Core™ based processor, such as a Quark™, an Atom™, an i3, an i5, an i7, or an MCU-class processor, or another such processor available from Intel® Corporation, Santa Clara, Calif. The processors of the application circuitry 405 may also be one or more of Advanced Micro Devices (AMD) Ryzen® processor(s) or Accelerated Processing Units (APUs); A5-A9 processor(s) from Apple® Inc., Snapdragon™ processor(s) from Qualcomm® Technologies, Inc., Texas Instruments, Inc.® Open Multimedia Applications Platform (OMAP)™ processor(s); a MIPS-based design from MIPS Technologies, Inc. such as MIPS Warrior M-class, Warrior I-class, and Warrior P-class processors; an ARM-based design licensed from ARM Holdings, Ltd., such as the ARM Cortex-A, Cortex-R, and Cortex-M family of processors; or the like. In some implementations, the application circuitry 405 may be a part of a system on a chip (SoC) in which the application circuitry 405 and other components are formed into a single integrated circuit, or a single package, such as the Edison™ or Galileo™ SoC boards from Intel® Corporation.

Additionally or alternatively, application circuitry 405 may include circuitry such as, but not limited to, one or more a field-programmable devices (FPDs) such as FPGAs and the like; programmable logic devices (PLDs) such as complex PLDs (CPLDs), high-capacity PLDs (HCPLDs), and the like; ASICs such as structured ASICs and the like; programmable SoCs (PSoCs); and the like. In such embodiments, the circuitry of application circuitry 405 may comprise logic blocks or logic fabric, and other interconnected resources that may be programmed to perform various functions, such as the procedures, methods, functions, etc. of the various embodiments discussed herein. In such embodiments, the circuitry of application circuitry 405 may include memory cells (e.g., erasable programmable read-only memory (EPROM), electrically erasable programmable read-only memory (EEPROM), flash memory, static memory (e.g., static random access memory (SRAM), anti-fuses, etc.)) used to store logic blocks, logic fabric, data, etc. in look-up tables (LUTs) and the like.

The baseband circuitry 410 may be implemented, for example, as a solder-down substrate including one or more integrated circuits, a single packaged integrated circuit soldered to a main circuit board or a multi-chip module containing two or more integrated circuits. The various hardware electronic elements of baseband circuitry 410 are discussed infra with regard to FIG. 5.

The RFEMs 415 may comprise a millimeter wave (mmWave) RFEM and one or more sub-mmWave radio frequency integrated circuits (RFICs). In some implementations, the one or more sub-mmWave RFICs may be physically separated from the mmWave RFEM. The RFICs may include connections to one or more antennas or antenna arrays (see e.g., antenna array 5111 of FIG. 5 infra), and the RFEM may be connected to multiple antennas. In alternative implementations, both mmWave and sub-mmWave radio functions may be implemented in the same physical RFEM 415, which incorporates both mmWave antennas and sub-mmWave.

The memory circuitry 420 may include any number and type of memory devices used to provide for a given amount of system memory. As examples, the memory circuitry 420 may include one or more of volatile memory including random access memory (RAM), dynamic RAM (DRAM) and/or synchronous dynamic RAM (SDRAM), and nonvolatile memory (NVM) including high-speed electrically erasable memory (commonly referred to as Flash memory), phase change random access memory (PRAM), magnetoresistive random access memory (MRAM), etc. The memory circuitry 420 may be developed in accordance with a Joint Electron Devices Engineering Council (JEDEC) low power double data rate (LPDDR)-based design, such as LPDDR2, LPDDR3, LPDDR4, or the like. Memory circuitry 420 may be implemented as one or more of solder down packaged integrated circuits, single die package (SDP), dual die package (DDP) or quad die package (Q17P), socketed memory modules, dual inline memory modules (DIMMs) including microDIMMs or MiniDIMMs, and/or soldered onto a motherboard via a ball grid array (BGA). In low power implementations, the memory circuitry 420 may be on-die memory or registers associated with the application circuitry 405. To provide for persistent storage of information such as data, applications, operating systems and so forth, memory circuitry 420 may include one or more mass storage devices, which may include, inter alia, a solid state disk drive (SSDD), hard disk drive (HDD), a micro HDD, resistance change memories, phase change memories, holographic memories, or chemical memories, among others. For example, the computer platform 400 may incorporate the three-dimensional (3D) cross-point (XPOINT) memories from Intel® and Micron®.

Removable memory circuitry 423 may include devices, circuitry, enclosures/housings, ports or receptacles, etc. used to couple portable data storage devices with the platform 400. These portable data storage devices may be used for mass storage purposes, and may include, for example, flash memory cards (e.g., Secure Digital (SD) cards, microSD cards, xD picture cards, and the like), and USB flash drives, optical discs, external HDDs, and the like.

The platform 400 may also include interface circuitry (not shown) that is used to connect external devices with the platform 400. The external devices connected to the platform 400 via the interface circuitry include sensor circuitry 421 and electro-mechanical components (EMCs) 422, as well as removable memory devices coupled to removable memory circuitry 423.

The sensor circuitry 421 include devices, modules, or subsystems whose purpose is to detect events or changes in its environment and send the information (sensor data) about the detected events to some other a device, module, subsystem, etc. Examples of such sensors include, inter alia, inertia measurement units (IMUs) comprising accelerometers, gyroscopes, and/or magnetometers; microelectromechanical systems (MEMS) or nanoelectromechanical systems (NEMS) comprising 3-axis accelerometers, 3-axis gyroscopes, and/or magnetometers; level sensors; flow sensors; temperature sensors (e.g., thermistors); pressure sensors; barometric pressure sensors; gravimeters; altimeters; image capture devices (e.g., cameras or lensless apertures); light detection and ranging (LiDAR) sensors; proximity sensors (e.g., infrared radiation detector and the like), depth sensors, ambient light sensors, ultrasonic transceivers; microphones or other like audio capture devices; etc.

EMCs 422 include devices, modules, or subsystems whose purpose is to enable platform 400 to change its state, position, and/or orientation, or move or control a mechanism or (sub)system. Additionally, EMCs 422 may be configured to generate and send messages/signalling to other components of the platform 400 to indicate a current state of the EMCs 422. Examples of the EMCs 422 include one or more power switches, relays including electromechanical relays (EMRs) and/or solid state relays (SSRs), actuators (e.g., valve actuators, etc.), an audible sound generator, a visual warning device, motors (e.g., DC (Direct Current) motors, stepper motors, etc.), wheels, thrusters, propellers, claws, clamps, hooks, and/or other like electro-mechanical components. In embodiments, platform 400 is configured to operate one or more EMCs 422 based on one or more captured events and/or instructions or control signals received from a service provider and/or various clients.

In some implementations, the interface circuitry may connect the platform 400 with positioning circuitry 445. The positioning circuitry 445 includes circuitry to receive and decode signals transmitted/broadcasted by a positioning network of a GNSS. Examples of navigation satellite constellations (or GNSS) include United States' GPS, Russia's GLONASS, the European Union's Galileo system, China's BeiDou Navigation Satellite System, a regional navigation system or GNSS augmentation system (e.g., NAVIC), Japan's QZSS, France's DORIS, etc.), or the like. The positioning circuitry 445 comprises various hardware elements (e.g., including hardware devices such as switches, filters, amplifiers, antenna elements, and the like to facilitate OTA communications) to communicate with components of a positioning network, such as navigation satellite constellation nodes. In some embodiments, the positioning circuitry 445 may include a Micro-PNT IC that uses a master timing clock to perform position tracking/estimation without GNSS assistance. The positioning circuitry 445 may also be part of, or interact with, the baseband circuitry 310 and/or RFEMs 415 to communicate with the nodes and components of the positioning network. The positioning circuitry 445 may also provide position data and/or time data to the application circuitry 405, which may use the data to synchronize operations with various infrastructure (e.g., radio base stations), for turn-by-turn navigation applications, or the like

In some implementations, the interface circuitry may connect the platform 400 with Near-Field Communication (NFC) circuitry 440. NFC circuitry 440 is configured to provide contactless, short-range communications based on radio frequency identification (RFID) standards, wherein magnetic field induction is used to enable communication between NFC circuitry 440 and NFC-enabled devices external to the platform 400 (e.g., an “NFC touchpoint”). NFC circuitry 440 comprises an NFC controller coupled with an antenna element and a processor coupled with the NFC controller. The NFC controller may be a chip/IC providing NFC functionalities to the NFC circuitry 440 by executing NFC controller firmware and an NFC stack. The NFC stack may be executed by the processor to control the NFC controller, and the NFC controller firmware may be executed by the NFC controller to control the antenna element to emit short-range RF signals. The RF signals may power a passive NFC tag (e.g., a microchip embedded in a sticker or wristband) to transmit stored data to the NFC circuitry 440, or initiate data transfer between the NFC circuitry 440 and another active NFC device (e.g., a smartphone or an NFC-enabled POS terminal) that is proximate to the platform 400.

The driver circuitry 446 may include software and hardware elements that operate to control particular devices that are embedded in the platform 400, attached to the platform 400, or otherwise communicatively coupled with the platform 400. The driver circuitry 446 may include individual drivers allowing other components of the platform 400 to interact with or control various input/output (I/O) devices that may be present within, or connected to, the platform 400. For example, driver circuitry 446 may include a display driver to control and allow access to a display device, a touchscreen driver to control and allow access to a touchscreen interface of the platform 400, sensor drivers to obtain sensor readings of sensor circuitry 421 and control and allow access to sensor circuitry 421, EMC drivers to obtain actuator positions of the EMCs 422 and/or control and allow access to the EMCs 422, a camera driver to control and allow access to an embedded image capture device, audio drivers to control and allow access to one or more audio devices.

The power management integrated circuitry (PMIC) 425 (also referred to as “power management circuitry 425”) may manage power provided to various components of the platform 400. In particular, with respect to the baseband circuitry 410, the PMIC 425 may control power-source selection, voltage scaling, battery charging, or DC-to-DC conversion. The PMIC 425 may often be included when the platform 400 is capable of being powered by a battery 430, for example, when the device is included in a UE 101, 102, 201.

In some embodiments, the PMIC 425 may control, or otherwise be part of, various power saving mechanisms of the platform 400. For example, if the platform 400 is in an RRC Connected state, where it is still connected to the RAN node as it expects to receive traffic shortly, then it may enter a state known as Discontinuous Reception Mode (DRX) after a period of inactivity. During this state, the platform 400 may power down for brief intervals of time and thus save power. If there is no data traffic activity for an extended period of time, then the platform 400 may transition off to an RRC Idle state, where it disconnects from the network and does not perform operations such as channel quality feedback, handover, etc. The platform 400 goes into a very low power state and it performs paging where again it periodically wakes up to listen to the network and then powers down again. The platform 400 may not receive data in this state; in order to receive data, it must transition back to RRC Connected state. An additional power saving mode may allow a device to be unavailable to the network for periods longer than a paging interval (ranging from seconds to a few hours). During this time, the device is totally unreachable to the network and may power down completely. Any data sent during this time incurs a large delay and it is assumed the delay is acceptable.

A battery 430 may power the platform 400, although in some examples the platform 400 may be mounted deployed in a fixed location, and may have a power supply coupled to an electrical grid. The battery 430 may be a lithium ion battery, a metal-air battery, such as a zinc-air battery, an aluminum-air battery, a lithium-air battery, and the like. In some implementations, such as in V2X applications, the battery 430 may be a typical lead-acid automotive battery.

In some implementations, the battery 430 may be a “smart battery,” which includes or is coupled with a Battery Management System (BMS) or battery monitoring integrated circuitry. The BMS may be included in the platform 400 to track the state of charge (SoCh) of the battery 430. The BMS may be used to monitor other parameters of the battery 430 to provide failure predictions, such as the state of health (SoH) and the state of function (SoF) of the battery 430. The BMS may communicate the information of the battery 430 to the application circuitry 405 or other components of the platform 400. The BMS may also include an analog-to-digital (ADC) convertor that allows the application circuitry 405 to directly monitor the voltage of the battery 430 or the current flow from the battery 430. The battery parameters may be used to determine actions that the platform 400 may perform, such as transmission frequency, network operation, sensing frequency, and the like.

A power block, or other power supply coupled to an electrical grid may be coupled with the BMS to charge the battery 430. In some examples, the power block XS30 may be replaced with a wireless power receiver to obtain the power wirelessly, for example, through a loop antenna in the computer platform 400. In these examples, a wireless battery charging circuit may be included in the BMS. The specific charging circuits chosen may depend on the size of the battery 430, and thus, the current required. The charging may be performed using the Airfuel standard promulgated by the Airfuel Alliance, the Qi wireless charging standard promulgated by the Wireless Power Consortium, or the Rezence charging standard promulgated by the Alliance for Wireless Power, among others.

User interface circuitry 450 includes various input/output (I/O) devices present within, or connected to, the platform 400, and includes one or more user interfaces designed to enable user interaction with the platform 400 and/or peripheral component interfaces designed to enable peripheral component interaction with the platform 400. The user interface circuitry 450 includes input device circuitry and output device circuitry. Input device circuitry includes any physical or virtual means for accepting an input including, inter alia, one or more physical or virtual buttons (e.g., a reset button), a physical keyboard, keypad, mouse, touchpad, touchscreen, microphones, scanner, headset, and/or the like. The output device circuitry includes any physical or virtual means for showing information or otherwise conveying information, such as sensor readings, actuator position(s), or other like information. Output device circuitry may include any number and/or combinations of audio or visual display, including, inter alia, one or more simple visual outputs/indicators (e.g., binary status indicators (e.g., light emitting diodes (LEDs)) and multi-character visual outputs, or more complex outputs such as display devices or touchscreens (e.g., Liquid Chrystal Displays (LCD), LED displays, quantum dot displays, projectors, etc.), with the output of characters, graphics, multimedia objects, and the like being generated or produced from the operation of the platform 400. The output device circuitry may also include speakers or other audio emitting devices, printer(s), and/or the like. In some embodiments, the sensor circuitry 421 may be used as the input device circuitry (e.g., an image capture device, motion capture device, or the like) and one or more EMCs may be used as the output device circuitry (e.g., an actuator to provide haptic feedback or the like). In another example, NFC circuitry comprising an NFC controller coupled with an antenna element and a processing device may be included to read electronic tags and/or connect with another NFC-enabled device. Peripheral component interfaces may include, but are not limited to, a non-volatile memory port, a USB port, an audio jack, a power supply interface, etc.

Although not shown, the components of platform 400 may communicate with one another using a suitable bus or interconnect (IX) technology, which may include any number of technologies, including ISA, EISA, PCI, PCIx, PCIe, a Time-Trigger Protocol (TTP) system, a FlexRay system, or any number of other technologies. The bus/IX may be a proprietary bus/IX, for example, used in a SoC based system. Other bus/IX systems may be included, such as an I²C interface, an SPI interface, point-to-point interfaces, and a power bus, among others.

FIG. 5 illustrates example components of baseband circuitry 5110 and radio front end modules (RFEM) 5115 in accordance with various embodiments. The baseband circuitry 5110 corresponds to the baseband circuitry 310 and 410 of FIGS. 3 and 4, respectively. The RFEM 5115 corresponds to the RFEM 315 and 415 of FIGS. 3 and 4, respectively. As shown, the RFEMs 5115 may include Radio Frequency (RF) circuitry 5106, front-end module (FEM) circuitry 5108, antenna array 5111 coupled together at least as shown.

The baseband circuitry 5110 includes circuitry and/or control logic configured to carry out various radio/network protocol and radio control functions that enable communication with one or more radio networks via the RF circuitry 5106. The radio control functions may include, but are not limited to, signal modulation/demodulation, encoding/decoding, radio frequency shifting, etc. In some embodiments, modulation/demodulation circuitry of the baseband circuitry 5110 may include Fast-Fourier Transform (FFT), precoding, or constellation mapping/demapping functionality. In some embodiments, encoding/decoding circuitry of the baseband circuitry 5110 may include convolution, tail-biting convolution, turbo, Viterbi, or Low Density Parity Check (LDPC) encoder/decoder functionality. Embodiments of modulation/demodulation and encoder/decoder functionality are not limited to these examples and may include other suitable functionality in other embodiments. The baseband circuitry 5110 is configured to process baseband signals received from a receive signal path of the RF circuitry 5106 and to generate baseband signals for a transmit signal path of the RF circuitry 5106. The baseband circuitry 5110 is configured to interface with application circuitry 305/405 (see FIGS. 3 and 4) for generation and processing of the baseband signals and for controlling operations of the RF circuitry 5106. The baseband circuitry 5110 may handle various radio control functions.

The aforementioned circuitry and/or control logic of the baseband circuitry 5110 may include one or more single or multi-core processors. For example, the one or more processors may include a 3G baseband processor 5104A, a 4G/LTE baseband processor 5104B, a 5G/NR baseband processor 5104C, or some other baseband processor(s) 5104D for other existing generations, generations in development or to be developed in the future (e.g., sixth generation (6G), etc.). In other embodiments, some or all of the functionality of baseband processors 5104A-D may be included in modules stored in the memory 5104G and executed via a Central Processing Unit (CPU) 5104E. In other embodiments, some or all of the functionality of baseband processors 5104A-D may be provided as hardware accelerators (e.g., FPGAs, ASICs, etc.) loaded with the appropriate bit streams or logic blocks stored in respective memory cells. In various embodiments, the memory 5104G may store program code of a real-time OS (RTOS), which when executed by the CPU 5104E (or other baseband processor), is to cause the CPU 5104E (or other baseband processor) to manage resources of the baseband circuitry 5110, schedule tasks, etc. Examples of the RTOS may include Operating System Embedded (OSE)™ provided by Enea®, Nucleus RTOS™ provided by Mentor Graphics®, Versatile Real-Time Executive (VRTX) provided by Mentor Graphics®, ThreadX™ provided by Express Logic®, FreeRTOS, REX OS provided by Qualcomm®, OKL4 provided by Open Kernel (OK) Labs®, or any other suitable RTOS, such as those discussed herein. In addition, the baseband circuitry 5110 includes one or more audio digital signal processor(s) (DSP) 5104F. The audio DSP(s) 5104F include elements for compression/decompression and echo cancellation and may include other suitable processing elements in other embodiments.

In some embodiments, each of the processors 5104A-5104E include respective memory interfaces to send/receive data to/from the memory 5104G. The baseband circuitry 5110 may further include one or more interfaces to communicatively couple to other circuitries/devices, such as an interface to send/receive data to/from memory external to the baseband circuitry 5110; an application circuitry interface to send/receive data to/from the application circuitry 305/405 of FIGS. 3-5); an RF circuitry interface to send/receive data to/from RF circuitry 5106 of FIG. 5; a wireless hardware connectivity interface to send/receive data to/from one or more wireless hardware elements (e.g., Near Field Communication (NFC) components, Bluetooth®/Bluetooth® Low Energy components, Wi-Fi® components, and/or the like); and a power management interface to send/receive power or control signals to/from the PMIC 425.

In alternate embodiments (which may be combined with the above described embodiments), baseband circuitry 5110 comprises one or more digital baseband systems, which are coupled with one another via an interconnect subsystem and to a CPU subsystem, an audio subsystem, and an interface subsystem. The digital baseband subsystems may also be coupled to a digital baseband interface and a mixed-signal baseband subsystem via another interconnect subsystem. Each of the interconnect subsystems may include a bus system, point-to-point connections, network-on-chip (NOC) structures, and/or some other suitable bus or interconnect technology, such as those discussed herein. The audio subsystem may include DSP circuitry, buffer memory, program memory, speech processing accelerator circuitry, data converter circuitry such as analog-to-digital and digital-to-analog converter circuitry, analog circuitry including one or more of amplifiers and filters, and/or other like components. In an aspect of the present disclosure, baseband circuitry 5110 may include protocol processing circuitry with one or more instances of control circuitry (not shown) to provide control functions for the digital baseband circuitry and/or radio frequency circuitry (e.g., the radio front end modules 5115).

Although not shown by FIG. 5, in some embodiments, the baseband circuitry 5110 includes individual processing device(s) to operate one or more wireless communication protocols (e.g., a “multi-protocol baseband processor” or “protocol processing circuitry”) and individual processing device(s) to implement PHY layer functions. In these embodiments, the PHY layer functions include the aforementioned radio control functions. In these embodiments, the protocol processing circuitry operates or implements various protocol layers/entities of one or more wireless communication protocols. In a first example, the protocol processing circuitry may operate LTE protocol entities and/or 5G/NR protocol entities when the baseband circuitry 5110 and/or RF circuitry 5106 are part of mmWave communication circuitry or some other suitable cellular communication circuitry. In the first example, the protocol processing circuitry would operate MAC, RLC, PDCP (Packet Data Convergence Protocol, Packet Data Convergence Protocol layer), SDAP (Service Data Adaptation Protocol, Service Data Adaptation Protocol layer), RRC, and NAS functions. In a second example, the protocol processing circuitry may operate one or more IEEE-based protocols when the baseband circuitry 5110 and/or RF circuitry 5106 are part of a Wi-Fi communication system. In the second example, the protocol processing circuitry would operate Wi-Fi MAC and logical link control (LLC) functions. The protocol processing circuitry may include one or more memory structures (e.g., 5104G) to store program code and data for operating the protocol functions, as well as one or more processing cores to execute the program code and perform various operations using the data. The baseband circuitry 5110 may also support radio communications for more than one wireless protocol.

The various hardware elements of the baseband circuitry 5110 discussed herein may be implemented, for example, as a solder-down substrate including one or more integrated circuits (ICs), a single packaged IC soldered to a main circuit board or a multi-chip module containing two or more ICs. In one example, the components of the baseband circuitry 5110 may be suitably combined in a single chip or chipset, or disposed on a same circuit board. In another example, some or all of the constituent components of the baseband circuitry 5110 and RF circuitry 5106 may be implemented together such as, for example, a system on a chip (SoC) or System-in-Package (SiP). In another example, some or all of the constituent components of the baseband circuitry 5110 may be implemented as a separate SoC that is communicatively coupled with and RF circuitry 5106 (or multiple instances of RF circuitry 5106). In yet another example, some or all of the constituent components of the baseband circuitry 5110 and the application circuitry 305/405 may be implemented together as individual SoCs mounted to a same circuit board (e.g., a “multi-chip package”).

In some embodiments, the baseband circuitry 5110 may provide for communication compatible with one or more radio technologies. For example, in some embodiments, the baseband circuitry 5110 may support communication with an E-UTRAN or other WMAN (Wireless Metropolitan Area Network), a WLAN, a WPAN (Wireless Personal Area Network). Embodiments in which the baseband circuitry 5110 is configured to support radio communications of more than one wireless protocol may be referred to as multi-mode baseband circuitry.

RF circuitry 5106 may enable communication with wireless networks using modulated electromagnetic radiation through a non-solid medium. In various embodiments, the RF circuitry 5106 may include switches, filters, amplifiers, etc. to facilitate the communication with the wireless network. RF circuitry 5106 may include a receive signal path, which may include circuitry to down-convert RF signals received from the FEM circuitry 5108 and provide baseband signals to the baseband circuitry 5110. RF circuitry 5106 may also include a transmit signal path, which may include circuitry to up-convert baseband signals provided by the baseband circuitry 5110 and provide RF output signals to the FEM circuitry 5108 for transmission.

In some embodiments, the receive signal path of the RF circuitry 5106 may include mixer circuitry 5106a, amplifier circuitry 5106b and filter circuitry 5106c. In some embodiments, the transmit signal path of the RF circuitry 5106 may include filter circuitry 5106c and mixer circuitry 5106a. RF circuitry 5106 may also include synthesizer circuitry 5106d for synthesizing a frequency for use by the mixer circuitry 5106a of the receive signal path and the transmit signal path. In some embodiments, the mixer circuitry 5106a of the receive signal path may be configured to down-convert RF signals received from the FEM circuitry 5108 based on the synthesized frequency provided by synthesizer circuitry 5106d. The amplifier circuitry 5106b may be configured to amplify the down-converted signals and the filter circuitry 5106c may be a low-pass filter (LPF) or band-pass filter (BPF) configured to remove unwanted signals from the down-converted signals to generate output baseband signals. Output baseband signals may be provided to the baseband circuitry 5110 for further processing. In some embodiments, the output baseband signals may be zero-frequency baseband signals, although this is not a requirement. In some embodiments, mixer circuitry 5106a of the receive signal path may comprise passive mixers, although the scope of the embodiments is not limited in this respect.

In some embodiments, the mixer circuitry 5106a of the transmit signal path may be configured to up-convert input baseband signals based on the synthesized frequency provided by the synthesizer circuitry 5106d to generate RF output signals for the FEM circuitry 5108. The baseband signals may be provided by the baseband circuitry 5110 and may be filtered by filter circuitry 5106c.

In some embodiments, the mixer circuitry 5106a of the receive signal path and the mixer circuitry 5106a of the transmit signal path may include two or more mixers and may be arranged for quadrature downconversion and upconversion, respectively. In some embodiments, the mixer circuitry 5106a of the receive signal path and the mixer circuitry 5106a of the transmit signal path may include two or more mixers and may be arranged for image rejection (e.g., Hartley image rejection). In some embodiments, the mixer circuitry 5106a of the receive signal path and the mixer circuitry 5106a of the transmit signal path may be arranged for direct downconversion and direct upconversion, respectively. In some embodiments, the mixer circuitry 5106a of the receive signal path and the mixer circuitry 5106a of the transmit signal path may be configured for super-heterodyne operation.

In some embodiments, the output baseband signals and the input baseband signals may be analog baseband signals, although the scope of the embodiments is not limited in this respect. In some alternate embodiments, the output baseband signals and the input baseband signals may be digital baseband signals. In these alternate embodiments, the RF circuitry 5106 may include analog-to-digital converter (ADC) and digital-to-analog converter (DAC) circuitry and the baseband circuitry 5110 may include a digital baseband interface to communicate with the RF circuitry 5106.

In some dual-mode embodiments, a separate radio IC circuitry may be provided for processing signals for each spectrum, although the scope of the embodiments is not limited in this respect.

In some embodiments, the synthesizer circuitry 5106d may be a fractional-N synthesizer or a fractional N/N+1 synthesizer, although the scope of the embodiments is not limited in this respect as other types of frequency synthesizers may be suitable. For example, synthesizer circuitry 5106d may be a delta-sigma synthesizer, a frequency multiplier, or a synthesizer comprising a phase-locked loop with a frequency divider.

The synthesizer circuitry 5106d may be configured to synthesize an output frequency for use by the mixer circuitry 5106a of the RF circuitry 5106 based on a frequency input and a divider control input. In some embodiments, the synthesizer circuitry 5106d may be a fractional N/N+1 synthesizer.

In some embodiments, frequency input may be provided by a voltage controlled oscillator (VCO), although that is not a requirement. Divider control input may be provided by either the baseband circuitry 5110 or the application circuitry 305/405 depending on the desired output frequency. In some embodiments, a divider control input (e.g., N) may be determined from a look-up table based on a channel indicated by the application circuitry 305/405.

Synthesizer circuitry 5106d of the RF circuitry 5106 may include a divider, a delay-locked loop (DLL), a multiplexer and a phase accumulator. In some embodiments, the divider may be a dual modulus divider (DMD) and the phase accumulator may be a digital phase accumulator (DPA). In some embodiments, the DMD may be configured to divide the input signal by either N or N+1 (e.g., based on a carry out) to provide a fractional division ratio. In some example embodiments, the DLL may include a set of cascaded, tunable, delay elements, a phase detector, a charge pump and a D-type flip-flop. In these embodiments, the delay elements may be configured to break a VCO period up into Nd equal packets of phase, where Nd is the number of delay elements in the delay line. In this way, the DLL provides negative feedback to help ensure that the total delay through the delay line is one VCO cycle.

In some embodiments, synthesizer circuitry 5106d may be configured to generate a carrier frequency as the output frequency, while in other embodiments, the output frequency may be a multiple of the carrier frequency (e.g., twice the carrier frequency, four times the carrier frequency) and used in conjunction with quadrature generator and divider circuitry to generate multiple signals at the carrier frequency with multiple different phases with respect to each other. In some embodiments, the output frequency may be a LO frequency (fLO). In some embodiments, the RF circuitry 5106 may include an IQ/polar converter.

FEM circuitry 5108 may include a receive signal path, which may include circuitry configured to operate on RF signals received from antenna array 5111, amplify the received signals and provide the amplified versions of the received signals to the RF circuitry 5106 for further processing. FEM circuitry 5108 may also include a transmit signal path, which may include circuitry configured to amplify signals for transmission provided by the RF circuitry 5106 for transmission by one or more of antenna elements of antenna array 5111. In various embodiments, the amplification through the transmit or receive signal paths may be done solely in the RF circuitry 5106, solely in the FEM circuitry 5108, or in both the RF circuitry 5106 and the FEM circuitry 5108.

In some embodiments, the FEM circuitry 5108 may include a TX (Transmission, Transmitting, Transmitter)/RX switch to switch between transmit mode and receive mode operation. The FEM circuitry 5108 may include a receive signal path and a transmit signal path. The receive signal path of the FEM circuitry 5108 may include an LNA to amplify received RF signals and provide the amplified received RF signals as an output (e.g., to the RF circuitry 5106). The transmit signal path of the FEM circuitry 5108 may include a power amplifier (PA) to amplify input RF signals (e.g., provided by RF circuitry 5106), and one or more filters to generate RF signals for subsequent transmission by one or more antenna elements of the antenna array 5111.

The antenna array 5111 comprises one or more antenna elements, each of which is configured convert electrical signals into radio waves to travel through the air and to convert received radio waves into electrical signals. For example, digital baseband signals provided by the baseband circuitry 5110 is converted into analog RF signals (e.g., modulated waveform) that will be amplified and transmitted via the antenna elements of the antenna array 5111 including one or more antenna elements (not shown). The antenna elements may be omnidirectional, direction, or a combination thereof. The antenna elements may be formed in a multitude of arranges as are known and/or discussed herein. The antenna array 5111 may comprise microstrip antennas or printed antennas that are fabricated on the surface of one or more printed circuit boards. The antenna array 5111 may be formed in as a patch of metal foil (e.g., a patch antenna) in a variety of shapes, and may be coupled with the RF circuitry 5106 and/or FEM circuitry 5108 using metal transmission lines or the like.

Processors of the application circuitry 305/405 and processors of the baseband circuitry 5110 may be used to execute elements of one or more instances of a protocol stack. For example, processors of the baseband circuitry 5110, alone or in combination, may be used execute Layer 3, Layer 2, or Layer 1 functionality, while processors of the application circuitry 305/405 may utilize data (e.g., packet data) received from these layers and further execute Layer 4 functionality (e.g., TCP (Transmission Communication Protocol) and UDP layers). As referred to herein, Layer 3 may comprise a RRC layer, described in further detail below. As referred to herein, Layer 2 may comprise a MAC layer, an RLC layer, and a PDCP layer, described in further detail below. As referred to herein, Layer 1 may comprise a PHY layer of a UE/RAN node, described in further detail below.

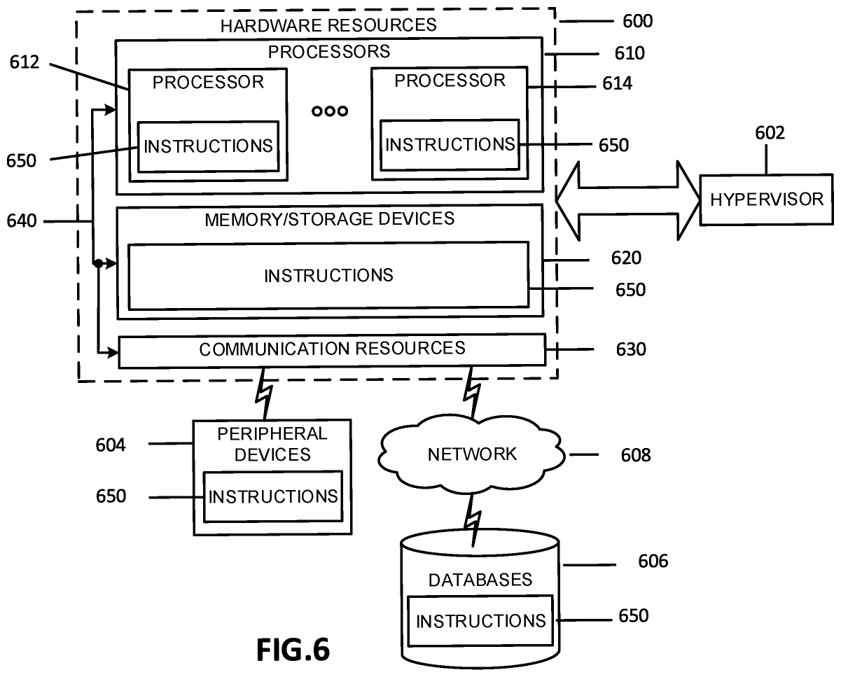

FIG. 6 is a block diagram illustrating components, according to some example embodiments, able to read instructions from a machine-readable or computer-readable medium (e.g., a non-transitory machine-readable storage medium) and perform any one or more of the methodologies discussed herein. Specifically, FIG. 6 shows a diagrammatic representation of hardware resources 600 including one or more processors (or processor cores) 610, one or more memory/storage devices 620, and one or more communication resources 630, each of which may be communicatively coupled via a bus 640. For embodiments where node virtualization (e.g., NFV) is utilized, a hypervisor 602 may be executed to provide an execution environment for one or more network slices/sub-slices to utilize the hardware resources 600.

The processors 610 may include, for example, a processor 612 and a processor 614. The processor(s) 610 may be, for example, a central processing unit (CPU), a reduced instruction set computing (RISC) processor, a complex instruction set computing (CISC) processor, a graphics processing unit (GPU), a DSP such as a baseband processor, an ASIC, an FPGA, a radio-frequency integrated circuit (RFIC), another processor (including those discussed herein), or any suitable combination thereof.

The memory/storage devices 620 may include main memory, disk storage, or any suitable combination thereof. The memory/storage devices 620 may include, but are not limited to, any type of volatile or nonvolatile memory such as dynamic random access memory (DRAM), static random access memory (SRAM), erasable programmable read-only memory (EPROM), electrically erasable programmable read-only memory (EEPROM), Flash memory, solid-state storage, etc.

The communication resources 630 may include interconnection or network interface components or other suitable devices to communicate with one or more peripheral devices 604 or one or more databases 606 via a network 608. For example, the communication resources 630 may include wired communication components (e.g., for coupling via USB), cellular communication components, NFC components, Bluetooth® (or Bluetooth® Low Energy) components, Wi-Fi® components, and other communication components.

Instructions 650 may comprise software, a program, an application, an applet, an app, or other executable code for causing at least any of the processors 610 to perform any one or more of the methodologies discussed herein. The instructions 650 may reside, completely or partially, within at least one of the processors 610 (e.g., within the processor's cache memory), the memory/storage devices 620, or any suitable combination thereof. Furthermore, any portion of the instructions 650 may be transferred to the hardware resources 600 from any combination of the peripheral devices 604 or the databases 606. Accordingly, the memory of processors 610, the memory/storage devices 620, the peripheral devices 604, and the databases 606 are examples of computer-readable and machine-readable media.

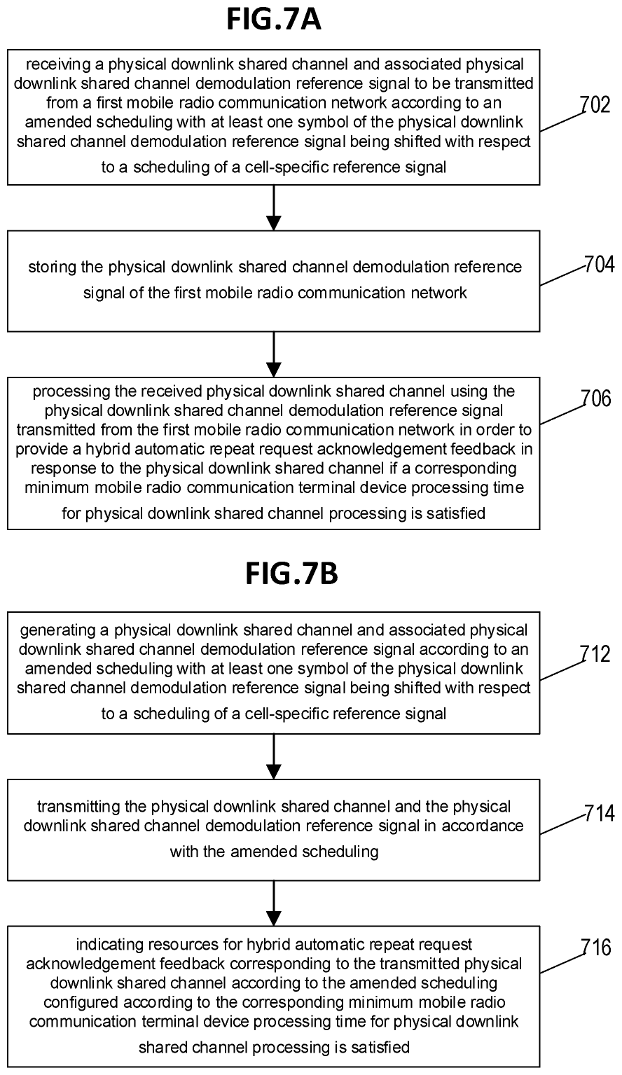

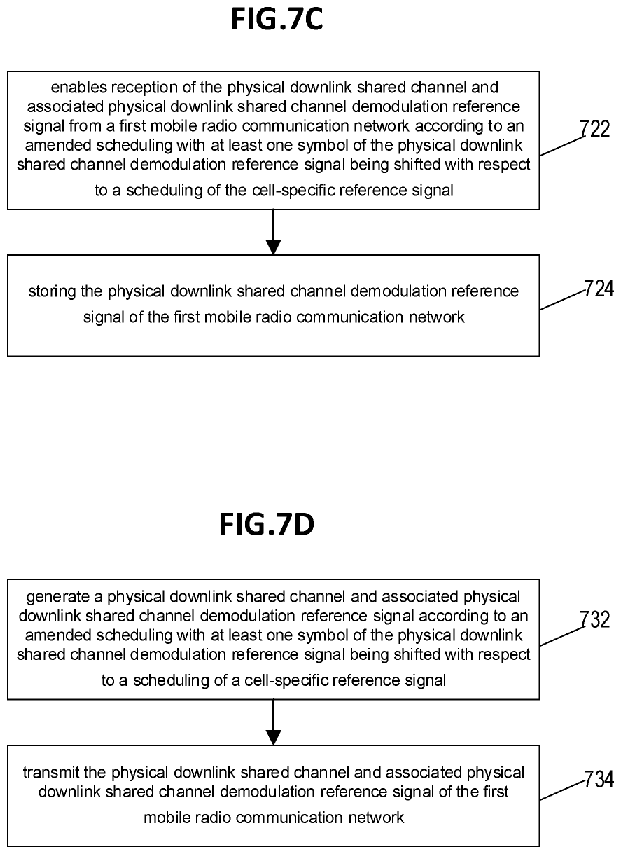

FIG. 7A-D illustrate a flow charts of methods according to various aspects. FIG. 7A illustrates a method for a mobile radio communication terminal device comprising receiving 702, by at least one receiver of the mobile radio communication terminal device, a physical downlink shared channel and associated physical downlink shared channel demodulation reference signal to be transmitted from a first mobile radio communication network according to an amended scheduling with at least one symbol of the physical downlink shared channel demodulation reference signal being shifted with respect to a scheduling of a cell-specific reference signal in case the mobile radio communication terminal device is operated during coinciding communications of the first mobile radio communication network and a second mobile radio communication network, wherein the second mobile radio communication network is configured to transmit the cell-specific reference signal; storing 704, by a memory of mobile radio communication terminal device, the physical downlink shared channel demodulation reference signal of the first mobile radio communication network; and processing 706, by one or more processors of the mobile radio communication terminal device, the received physical downlink shared channel using the physical downlink shared channel demodulation reference signal transmitted from the first mobile radio communication network in order to provide a hybrid automatic repeat request acknowledgement feedback in response to the physical downlink shared channel if a corresponding minimum mobile radio communication terminal device processing time for physical downlink shared channel processing is satisfied.

FIG. 7B illustrates a method for a mobile radio communication device comprising: generating 712, by one or more processors of the mobile radio communication device, a physical downlink shared channel and associated physical downlink shared channel demodulation reference signal according to an amended scheduling with at least one symbol of the physical downlink shared channel demodulation reference signal being shifted with respect to a scheduling of a cell-specific reference signal in case the mobile radio communication device is operated during coinciding communications of the first mobile radio communication network and a second mobile radio communication network, wherein the second mobile radio communication network is configured to transmit the cell-specific reference signal; transmitting 714, by at least one transmitter of the mobile radio communication device, the physical downlink shared channel and the physical downlink shared channel demodulation reference signal in accordance with the amended scheduling; and, indicating 716, by one or more processors of the mobile radio communication device, resources for hybrid automatic repeat request acknowledgement feedback corresponding to the transmitted physical downlink shared channel according to the amended scheduling configured according to the corresponding minimum mobile radio communication terminal device processing time for physical downlink shared channel processing is satisfied.

FIG. 7C illustrates a method for a non-transitory computer-readable storage medium storing program instructions, the program instructions, when executed by one or more processors of the mobile radio communication terminal device, enables reception 722 of the physical downlink shared channel and associated physical downlink shared channel demodulation reference signal from the first mobile radio communication network according to an amended scheduling with at least one symbol of the physical downlink shared channel demodulation reference signal being shifted with respect to a scheduling of the cell-specific reference signal in case the mobile radio communication terminal device is operated during coinciding communications of the first mobile radio communication network and a second mobile radio communication network, wherein the second mobile radio communication network is configured to transmit the cell-specific reference signal; and storing 724 the physical downlink shared channel demodulation reference signal of the first mobile radio communication network.

FIG. 7D illustrates a method for a non-transitory computer-readable storage medium storing program instructions, the program instructions, when executed by one or more processors of a mobile radio communication device, causes the mobile radio communication device to generate 732 a physical downlink shared channel and associated physical downlink shared channel demodulation reference signal according to an amended scheduling with at least one symbol of the physical downlink shared channel demodulation reference signal being shifted with respect to a scheduling of a cell-specific reference signal in case the mobile radio communication device is operated during coinciding communications of the first mobile radio communication network and a second mobile radio communication network, wherein the second mobile radio communication network is configured to transmit the cell-specific reference signal, and to transmit 734 the physical downlink shared channel and associated physical downlink shared channel demodulation reference signal of the first mobile radio communication network.

For one or more embodiments, at least one of the components set forth in one or more of the preceding figures may be configured to perform one or more operations, techniques, processes, and/or methods as set forth in the example section below. For example, the baseband circuitry as described above in connection with one or more of the preceding figures may be configured to operate in accordance with one or more of the examples set forth below. For another example, circuitry associated with a UE, base station, network element, etc. as described above in connection with one or more of the preceding figures may be configured to operate in accordance with one or more of the examples set forth below in the example section.

For one or more aspects, at least one of the components set forth in one or more of the preceding figures may be configured to perform one or more operations, techniques, processes, and/or methods as set forth in the example section below. For example, the baseband circuitry as described above in connection with one or more of the preceding figures may be configured to operate in accordance with one or more of the examples set forth below. For another example, circuitry associated with a UE, base station, network element, etc. as described above in connection with one or more of the preceding figures may be configured to operate in accordance with one or more of the examples set forth below in the example section.

### EXAMPLES

Example 1 is a mobile radio communication terminal device operable for facilitating a physical downlink shared channel, e.g. PDSCH (Physical Downlink Shared Channel), demodulation reference signal, e.g. PDSCH associated demodulation reference signal, of a first mobile radio communication network communication connection during coinciding communications of the first mobile radio communication network and a second mobile radio communication network. The second mobile radio communication network is configured to transmit a cell-specific reference signal. The mobile radio communication terminal device includes one or more processors configured to receive the physical downlink shared channel, e.g. PDSCH, and an associated demodulation reference signal, e.g. a PDSCH associated demodulation reference signal, to be transmitted from the first mobile radio communication network according to an amended scheduling with at least one of the symbols of the physical downlink shared channel demodulation reference signal being shifted with respect to the scheduling of the cell-specific reference signal; a memory storing the physical downlink shared channel and associated physical downlink shared channel demodulation reference signal of the first mobile radio communication network, and one or more processors configured to process the received physical downlink shared channel using the physical downlink shared channel demodulation reference signal of the first mobile radio communication network transmitted according to the amended scheduling in order to provide a hybrid automatic repeat request acknowledgement, e.g. HARQ-ACK, feedback in response to the physical downlink shared channel if the corresponding minimum mobile radio communication terminal device processing time for physical downlink shared channel processing is satisfied.

The amended scheduling of the demodulation reference signal may be a providing of at least one demodulation reference signal provided in a symbol within a physical downlink shared channel of duration D symbols, different from the cell-specific reference signal symbol of the second mobile communication network. Here, D is the number of symbols from slot boundary (symbol #0) to last symbol of the physical downlink shared channel in the slot of a frame of the first mobile communication network.

Example 2 includes the mobile radio communication terminal device example 1 and/or some other examples herein, wherein the mobile radio communication terminal device is a user equipment (UE).

Example 3 includes the mobile radio communication terminal device according to any one of examples 1 or 2 and/or some other examples herein, wherein the first mobile radio communication network is a 5G communication network and the demodulation reference signal is a demodulation reference signal of the 5G communication network. The 5G communication network may also be denoted as new radio (NR) communication network. The physical downlink shared channel demodulation reference signal may be denoted as PDSCH DMRS.

Example 4 includes the mobile radio communication terminal device according to any one of examples 1 to 3 and/or some other examples herein, wherein the second mobile radio communication network is a long term evolution (LTE) communication network and the cell-specific reference signal is a cell-specific reference signal of the LTE communication network. The cell-specific reference signal may be denoted as CRS.

Example 5 includes the mobile radio communication terminal device according to any one of examples 1 to 4 and/or some other examples herein, wherein the mobile radio communication terminal device includes at least one receiver configured to receive the demodulation reference signal.

Example 6 includes the mobile radio communication terminal device according to any one of examples 1 to 5 and/or some other examples herein, wherein the last single-symbol of the demodulation reference signal within the physical downlink shared channel is in symbol #12 of the slot when the mobile radio communication terminal device is configured with dmrs-AdditionalPosition=‘pos1’, or dmrs-AdditionalPosition=‘pos2’, or dmrs-AdditionalPosition=‘pos3’ when the mobile radio communication terminal device is configured with lte-CRS-ToMatchAround via higher layers of the open systems interconnection model.

Example 7 includes the mobile radio communication terminal device according to any one of examples 1 to 6 and/or some other examples herein, wherein the demodulation reference signal positions for the single-symbol demodulation reference signal for D=13, 14 for physical downlink shared channel mapping type A are defined such that the last single-symbol demodulation reference signal within the physical downlink shared channel is in symbol #12 of the slot when the mobile radio communication terminal device is configured with dmrs-AdditionalPosition=‘pos1’, or dmrs-AdditionalPosition=‘pos2’, or dmrs-AdditionalPosition=‘pos3’.

Example 8 includes the mobile radio communication terminal device according to any one of examples 1 to 7 and/or some other examples herein, wherein the demodulation reference signal positions for single-symbol demodulation reference signal for D=13, 14 for physical downlink shared channel mapping type A are defined such that, when the mobile radio communication terminal device is configured with dmrs-AdditionalPosition=‘pos2’, a first additional single-symbol demodulation reference signal position is in symbol #8 of the slot.

Example 9 includes the mobile radio communication terminal device according to any one of examples 1 to 8 and/or some other examples herein, wherein a first additional single-symbol demodulation reference signal position is in symbol #8 of the slot when the mobile radio communication terminal device is configured with dmrs-AdditionalPosition=‘pos2’ when the mobile radio communication terminal device is configured with lte-CRS-ToMatchAround via higher layers.

Example 10 includes the mobile radio communication terminal device according to any one of examples 1 to 11 and/or some other examples herein, wherein for the case of double-symbol demodulation reference signal, the demodulation reference signal positions are defined as (l₀, 12) for dmrs-AdditionalPosition=‘pos1’ when the physical downlink shared channel is scheduled such that D=14.

Example 11 includes the mobile radio communication terminal device according to any one of examples 1 to 10 and/or some other examples herein, wherein, irrespective of the mobile radio communication terminal device being configured with lte-CRS-ToMatchAround via higher layers of the open systems interconnection model, demodulation reference signal positions for additional demodulation reference signal symbols are applied in unicast and/or broadcast physical downlink shared channel.

Example 12 includes the mobile radio communication terminal device according to any one of examples 1 to 11 and/or some other examples herein, wherein the mapping of the additional demodulation reference signal to symbol #12 or #8 are applied only when the mobile radio communication terminal device is configured with lte-CRS-ToMatchAround via higher layers of the open systems interconnection model to unicast physical downlink shared channel,

Example 13 includes the mobile radio communication terminal device according to any one of examples 1 to 12 and/or some other examples herein, wherein unicast physical downlink shared channel is scheduled using physical downlink control channel (PDCCH) with cyclic redundancy check (CRC) scrambled with cell-radio network temporary identifier (C-RNTI), circuit switched-radio network temporary identifier (CS-RNTI), or Modulation and coding scheme-radio network temporary identifier (MCS-C-RNTI).

Example 14 includes the mobile radio communication terminal device according to any one of examples 1 to 13 and/or some other examples herein, wherein the minimum mobile radio communication terminal device processing time value (N1) in orthogonal frequency division multiplexing (OFDM) symbol is increased by one symbol when the last single-symbol demodulation reference signal location within the physical downlink shared channel is symbol #12 of the slot for physical downlink shared channel mapping type A in case the mobile radio communication terminal device is configured with dmrs-AdditionalPosition≠pos0 in DMRS-DownlinkConfig in either of dmrs-DownlinkForPDSCH-MappingTypeA, dmrs-DownlinkForPDSCH-MappingTypeB or if the high layer parameter of the open systems interconnection model is not configured.

Example 15 includes the mobile radio communication terminal device according to any one of examples 1 to 14 and/or some other examples herein, wherein the minimum mobile radio communication terminal device processing time value (N1) (in OFDM symbols) is increased by one symbol when the second demodulation reference signal location is symbol #12 of the slot for physical downlink shared channel mapping type A in case the mobile radio communication terminal device is configured with dmrs-AdditionalPosition=pos1 in DMRS-DownlinkConfig in dmrs-DownlinkForPDSCH-MappingTypeA.

Example 16 includes the mobile radio communication terminal device according to any one of examples 1 to 15 and/or some other examples herein, wherein in case of double-symbol demodulation reference signal the minimum mobile radio communication terminal device processing time value (N1) (in OFDM symbols) is increased by two symbols when the last double-symbol demodulation reference signal location within the physical downlink shared channel is symbol #12 of the slot for physical downlink shared channel mapping type A in case the mobile radio communication terminal device is configured with dmrs-AdditionalPosition≠pos0 in demodulation reference signal-DownlinkConfig in either of dmrs-DownlinkForphysical downlink shared channelMappingTypeA, dmrsDownlinkForphysical downlink shared channel-MappingTypeB or if the high layer parameter is not configured.

Example 17 includes the mobile radio communication terminal device according to any one of examples 1 to 16 and/or some other examples herein, wherein the minimum mobile radio communication terminal device processing time value (N1) (in OFDM symbols) is increased by two symbols when the last double-symbol demodulation reference signal location within the physical downlink shared channel is symbol #12 of the slot for physical downlink shared channel mapping type A in case the mobile radio communication terminal device is configured with dmrs-AdditionalPosition=pos1 in demodulation reference signal-DownlinkConfig in dmrs-DownlinkForphysical downlink shared channelMappingTypeA.

Example 18 includes the mobile radio communication terminal device according to any one of examples 1 to 17 and/or some other examples herein, wherein the physical downlink shared channel mapping type A is scheduled with D=8 or D=9 and the corresponding demodulation reference signal locations are defined for dmrs-AdditionalPosition=‘pos1’ as (l₀, 8), either irrespective of configuration of higher layer parameter lte-CRS-ToMatchAround or when higher layer parameter lte-CRS-ToMatchAround is configured to the mobile radio communication terminal device.

Example 19 includes the mobile radio communication terminal device according to any one of examples 1 to 18 and/or some other examples herein, wherein the physical downlink shared channel subcarrier spacing (SCS) of the scheduled physical downlink shared channel is 15 kHz.

Example 20 includes the mobile radio communication terminal device according to any one of examples 1 to 19 and/or some other examples herein, wherein the demodulation reference signal positions are defined for all SCS for the downlink (DL) bandwidth part (BWP) in which the physical downlink shared channel is scheduled.

Example 21 includes the mobile radio communication terminal device according to any one of examples 1 to 20 and/or some other examples herein, wherein the last demodulation reference signal symbol within the physical downlink shared channel duration is delayed.

Example 22 includes the mobile radio communication terminal device according to any one of examples 1 to 21 and/or some other examples herein, wherein symbol delay is applicable when μ=0 to determine the minimum physical downlink shared channel processing time as in Table 5.3-1 of TS38.214.

Example 23 is a mobile radio communication device operable for facilitating a physical downlink shared channel (PDSCH) and associated PDSCH demodulation reference signal of a first mobile radio communication network communication connection during coinciding communications of the first mobile radio communication network and a second mobile radio communication network, wherein the second mobile radio communication network is configured to transmit a cell-specific reference signal, the mobile radio communication device including: one or more processors configured to generate a demodulation reference signal to be received from the first mobile radio communication network according to an amended scheduling with at least one of the symbols of the PDSCH demodulation reference signal being shifted with respect to the scheduling of the cell-specific reference signal and to generate the demodulation reference signal in accordance with the amended scheduling; at least one transmitter to transmit the PDSCH and the PDSCH demodulation reference signal in accordance with the amended scheduling; and one or more processors configured to indicate resources for HARQ-ACK feedback corresponding to the transmitted PDSCH according to the amended scheduling such that the corresponding minimum mobile radio communication terminal device, e.g. UE, processing time for PDSCH processing is satisfied.

Example 24 includes the mobile radio communication device according to example 23 and/or some other examples herein, wherein the mobile radio communication device is a base station or a core network component.

Example 25 includes the mobile radio communication device according to any one of examples 23 or 24 and/or some other examples herein, wherein the first mobile radio communication network is a 5G communication network and the demodulation reference signal is a demodulation reference signal of the 5G communication network.

Example 26 includes the mobile radio communication terminal device according to any one of examples 23 to 25 and/or some other examples herein, wherein the second mobile radio communication network is a long term evolution (LTE) communication network and the cell-specific reference signal is a cell-specific reference signal of the LTE communication network.

Example 27 includes the mobile radio communication device according to any one of examples 23 to 26 and/or some other examples herein, wherein the mobile radio communication device includes at least one transmitter configured to transmit the physical downlink shared channel (PDSCH) and associated PDSCH demodulation reference signal of the first mobile radio communication network communication connection in accordance with the amended scheduling.

Example 28 includes the mobile radio communication device according to any one of examples 23 to 27 and/or some other examples herein, wherein the last single-symbol of the demodulation reference signal within the physical downlink shared channel is in symbol #12 of the slot when the mobile radio communication terminal device is configured with dmrs-AdditionalPosition=‘pos1’, or dmrs-AdditionalPosition=‘pos2’, or dmrs-AdditionalPosition=‘pos3’ when the mobile radio communication terminal device is configured with lte-CRS-ToMatchAround via higher layers of the open systems interconnection model.

Example 29 includes the mobile radio communication device according to any one of examples 23 to 28 and/or some other examples herein, wherein the demodulation reference signal positions for the single-symbol demodulation reference signal for D=13, 14 for physical downlink shared channel mapping type A are defined such that the last single-symbol demodulation reference signal within the physical downlink shared channel is in symbol #12 of the slot when the mobile radio communication terminal device is configured with dmrs-AdditionalPosition=‘pos1’, or dmrs-AdditionalPosition=‘pos2’, or dmrs-AdditionalPosition=‘pos3’.

Example 30 includes the mobile radio communication device according to any one of examples 23 to 29 and/or some other examples herein, wherein the demodulation reference signal positions for single-symbol demodulation reference signal for D=13, 14 for physical downlink shared channel mapping type A are defined such that, when the mobile radio communication terminal device is configured with dmrs-AdditionalPosition=‘pos2’, a first additional single-symbol demodulation reference signal position is in symbol #8 of the slot.

Example 31 includes the mobile radio communication device according to any one of examples 23 to 30 and/or some other examples herein, wherein a first additional single-symbol demodulation reference signal position is in symbol #8 of the slot when the mobile radio communication terminal device is configured with dmrs-AdditionalPosition=‘pos2’ when the mobile radio communication terminal device is configured with lte-CRS-ToMatchAround via higher layers.

Example 32 includes the mobile radio communication device according to any one of examples 23 to 31 and/or some other examples herein, wherein for the case of double-symbol demodulation reference signal, the demodulation reference signal positions are defined as (l₀, 12) for dmrs-AdditionalPosition=‘pos1’ when the physical downlink shared channel is scheduled such that D=14.

Example 33 includes the mobile radio communication device according to any one of examples 23 to 32 and/or some other examples herein, wherein, irrespective of the mobile radio communication terminal device being configured with lte-CRS-ToMatchAround via higher layers of the open systems interconnection model, demodulation reference signal positions for additional demodulation reference signal symbols are applied in unicast and/or broadcast physical downlink shared channel.

Example 34 includes the mobile radio communication device according to any one of examples 23 to 33 and/or some other examples herein, wherein the mapping to symbol #12 or #8 are applied only when the mobile radio communication terminal device is configured with lte-CRS-ToMatchAround via higher layers of the open systems interconnection model to unicast physical downlink shared channel,

Example 35 includes the mobile radio communication device according to any one of examples 23 to 34 and/or some other examples herein, wherein unicast physical downlink shared channel is scheduled using physical downlink control channel (PDCCH) with cyclic redundancy check (CRC) scrambled with cell-radio network temporary identifier (C-RNTI), circuit switched-radio network temporary identifier (CS-RNTI), or Modulation and coding scheme-radio network temporary identifier (MCS-C-RNTI).

Example 36 includes the mobile radio communication device according to any one of examples 23 to 35 and/or some other examples herein, wherein the minimum mobile radio communication terminal device processing time value (N1) in orthogonal frequency division multiplexing (OFDM) symbol) is increased by one symbol when the last single-symbol demodulation reference signal location within the physical downlink shared channel is symbol #12 of the slot for physical downlink shared channel mapping type A in case the mobile radio communication terminal device is configured with dmrs-AdditionalPosition≠pos0 in demodulation reference signal-DownlinkConfig in either of dmrs-DownlinkForphysical downlink shared channelMappingTypeA, dmrsDownlinkForphysical downlink shared channel-MappingTypeB or if the high layer parameter of the open systems interconnection model is not configured.

Example 37 includes the mobile radio communication device according to any one of examples 23 to 36 and/or some other examples herein, wherein the minimum mobile radio communication terminal device processing time value (N1) (in OFDM symbols) is increased by one symbol when the second demodulation reference signal location is symbol #12 of the slot for physical downlink shared channel mapping type A in case the mobile radio communication terminal device is configured with dmrs-AdditionalPosition=pos1 in demodulation reference signal-DownlinkConfig in dmrs-DownlinkForphysical downlink shared channelMappingTypeA.

Example 38 includes the mobile radio communication device according to any one of examples 23 to 37 and/or some other examples herein, wherein in case of double-symbol demodulation reference signal the minimum mobile radio communication terminal device processing time value (N1) (in OFDM symbols) is increased by two symbols when the last double-symbol demodulation reference signal location within the physical downlink shared channel is symbol #12 of the slot for physical downlink shared channel mapping type A in case the mobile radio communication terminal device is configured with dmrs-AdditionalPosition≠pos0 in demodulation reference signal-DownlinkConfig in either of dmrs-DownlinkForphysical downlink shared channelMappingTypeA, dmrsDownlinkForphysical downlink shared channel-MappingTypeB or if the high layer parameter is not configured.

Example 39 includes the mobile radio communication device according to any one of examples 23 to 38 and/or some other examples herein, wherein the minimum mobile radio communication terminal device processing time value (N1) (in OFDM symbols) is increased by two symbols when the last double-symbol demodulation reference signal location within the physical downlink shared channel is symbol #12 of the slot for physical downlink shared channel mapping type A in case the mobile radio communication terminal device is configured with dmrs-AdditionalPosition=pos1 in demodulation reference signal-DownlinkConfig in dmrs-DownlinkForphysical downlink shared channelMappingTypeA.

Example 40 includes the mobile radio communication device according to any one of examples 23 to 39 and/or some other examples herein, wherein the physical downlink shared channel mapping type A is scheduled with D=8 or D=9 and the corresponding demodulation reference signal locations are defined for dmrs-AdditionalPosition=‘pos1’ as (l₀, 8), either irrespective of configuration of higher layer parameter lte-CRS-ToMatchAround or when higher layer parameter lte-CRS-ToMatchAround is configured to the mobile radio communication terminal device.

Example 41 includes the mobile radio communication device according to any one of examples 23 to 40 and/or some other examples herein, wherein the physical downlink shared channel subcarrier spacing (SCS) of the scheduled physical downlink shared channel is 15 kHz.

Example 42 includes the mobile radio communication device according to any one of examples 23 to 41 and/or some other examples herein, wherein the demodulation reference signal positions are defined for all SCS for the downlink (DL) bandwidth part (BWP) in which the physical downlink shared channel is scheduled.

Example 43 includes the mobile radio communication device according to any one of examples 23 to 42 and/or some other examples herein, wherein the last demodulation reference signal symbol within the physical downlink shared channel duration is delayed.

Example 44 includes the mobile radio communication device according to any one of examples 23 to 43 and/or some other examples herein, wherein symbol delay is applicable when μ=0 to determine the minimum physical downlink shared channel processing time as in Table 5.3-1 of TS38.214.

Example 45 is a method for facilitating a physical downlink shared channel (PDSCH) in a first mobile radio communication network connection between a mobile radio communication device and a mobile radio communication terminal device during coinciding communications of the first mobile radio communication network and a second mobile radio communication network, wherein the second mobile radio communication network is configured to transmit a cell-specific reference signal, the method including: receiving the PDSCH and associated PDSCH demodulation reference signal according to an amended scheduling with at least one of the symbols of the PDSCH demodulation reference signal being shifted with respect to the scheduling of the cell-specific reference signal; storing the physical downlink shared channel demodulation reference signal of the first mobile radio communication network; and processing the received PDSCH using the PDSCH demodulation reference signal of the first mobile radio communication network transmitted according to the amended scheduling in order to provide a HARQ-ACK feedback in response to the PDSCH if the corresponding minimum mobile radio communication terminal device, e.g. processing time for PDSCH processing is satisfied.

Example 46 includes the method according to example 45 and/or some other examples herein, wherein the mobile radio communication terminal device is a user equipment (UE).

Example 47 includes the method according to any one of examples 45 or 46 and/or some other examples herein, wherein the mobile radio communication device is a base station or a core network component.

Example 48 includes the method according to any one of examples 45 to 47 and/or some other examples herein, wherein the first mobile radio communication network is a 5G communication network and the demodulation reference signal is a demodulation reference signal of the 5G communication network.

Example 49 includes the method according to any one of examples 45 to 48 and/or some other examples herein, wherein the second mobile radio communication network is a long term evolution (LTE) communication network and the cell-specific reference signal is a cell-specific reference signal of the LTE communication network.

Example 50 includes the method according to any one of examples 45 to 49 and/or some other examples herein, wherein the mobile radio communication device includes at least one transmitter configured to transmit the physical downlink shared channel demodulation reference signal of the first mobile radio communication network communication connection according to an amended scheduling with at least one of the symbols of the PDSCH demodulation reference signal being shifted with respect to the scheduling of the cell-specific reference signal.

Example 51 includes the method according to any one of examples 45 to 50 and/or some other examples herein, wherein the mobile radio communication terminal device includes at least one receiver configured to receive the physical downlink shared channel demodulation reference signal of the first mobile radio communication network communication connection according to an amended scheduling with at least one of the symbols of the PDSCH demodulation reference signal with at least one of the symbols of the PDSCH demodulation reference signal being shifted with respect to the scheduling of the cell-specific reference signal.

Example 52 includes a non-transitory computer-readable storage medium storing program instructions for facilitating a physical downlink shared channel, e.g. PDSCH, in a first mobile radio communication network connection between a mobile radio communication device and a mobile radio communication terminal device via a demodulation reference signal of the first mobile radio communication network during coinciding communications of the first mobile radio communication network and a second mobile radio communication network, wherein the second mobile radio communication network is configured to transmit a cell-specific reference signal, the program instructions, when executed by one or more processors of the mobile radio communication terminal device, enables reception of the PDSCH and associated PDSCH demodulation reference signal from the first mobile radio communication network according to an amended scheduling with at least one of the symbols of the PDSCH demodulation reference signal being shifted with respect to the scheduling of the cell-specific reference signal; and storing the physical downlink shared channel demodulation reference signal of the first mobile radio communication network.

Example 53 includes a non-transitory computer-readable storage medium storing program instructions for facilitating a physical downlink shared channel, e.g. PDSCH, in a first mobile radio communication network connection between a mobile radio communication device and a mobile radio communication terminal device via a demodulation reference signal of the first mobile radio communication network during coinciding communications of the first mobile radio communication network and a second mobile radio communication network, wherein the second mobile radio communication network is configured to transmit a cell-specific reference signal, the program instructions, when executed by one or more processors of the mobile radio communication device, the device to generate the PDSCH and associated PDSCH demodulation reference signal according to an amended scheduling with at least one of the symbols of the PDSCH demodulation reference signal being shifted with respect to the scheduling of the cell-specific reference signal; and to transmit the PDSCH and associated PDSCH demodulation reference signal of the first mobile radio communication network.

Example 54 includes the non-transitory computer-readable storage medium according to any one of examples 52 or 53 and/or some other examples herein, wherein the mobile radio communication terminal device is a user equipment (UE).

Example 55 includes the non-transitory computer-readable storage medium according to any one of examples 52 to 54 and/or some other examples herein, wherein the mobile radio communication device is a base station or a core network component.

Example 56 includes the non-transitory computer-readable storage medium according to any one of examples 52 to 55 and/or some other examples herein, wherein the first mobile radio communication network is a 5G communication network and the demodulation reference signal is a demodulation reference signal of the 5G communication network.

Example 57 includes the non-transitory computer-readable storage medium according to any one of examples 52 to 58 and/or some other examples herein, wherein the second mobile radio communication network is a long term evolution (LTE) communication network and the cell-specific reference signal is a cell-specific reference signal of the LTE communication network.

Example 58 includes the non-transitory computer-readable storage medium according to any one of examples 52 to 57 and/or some other examples herein, wherein the mobile radio communication device includes at least one transmitter configured to transmit the physical downlink shared channel demodulation reference signal of the first mobile radio communication network communication connection in accordance with the amended scheduling.

Example 59 includes the non-transitory computer-readable storage medium according to any one of examples 52 to 58 and/or some other examples herein, wherein the last single-symbol of the demodulation reference signal within the physical downlink shared channel is in symbol #12 of the slot when the mobile radio communication terminal device is configured with dmrs-AdditionalPosition=‘pos1’, or dmrs-AdditionalPosition=‘pos2’, or dmrs-AdditionalPosition=‘pos3’ when the mobile radio communication terminal device is configured with lte-CRS-ToMatchAround via higher layers of the open systems interconnection model.

Example 60 includes the non-transitory computer-readable storage medium according to any one of examples 52 to 59 and/or some other examples herein, wherein the demodulation reference signal positions for the single-symbol demodulation reference signal for D=13, 14 for physical downlink shared channel mapping type A are defined such that the last single-symbol demodulation reference signal within the physical downlink shared channel is in symbol #12 of the slot when the mobile radio communication terminal device is configured with dmrs-AdditionalPosition=‘pos1’, or dmrs-AdditionalPosition=‘pos2’, or dmrs-AdditionalPosition=‘pos3’.

Example 61 includes the non-transitory computer-readable storage medium according to any one of examples 52 to 60 and/or some other examples herein, wherein the demodulation reference signal positions for single-symbol demodulation reference signal for D=13, 14 for physical downlink shared channel mapping type A are defined such that, when the mobile radio communication terminal device is configured with dmrs-AdditionalPosition=‘pos2’, a first additional single-symbol demodulation reference signal position is in symbol #8 of the slot.

Example 62 includes the non-transitory computer-readable storage medium according to any one of examples 52 to 61 and/or some other examples herein, wherein a first additional single-symbol demodulation reference signal position is in symbol #8 of the slot when the mobile radio communication terminal device is configured with dmrs-AdditionalPosition=‘pos2’ when the mobile radio communication terminal device is configured with lte-CRS-ToMatchAround via higher layers.

Example 63 includes the non-transitory computer-readable storage medium according to any one of examples 52 to 62 and/or some other examples herein, wherein for the case of double-symbol demodulation reference signal, the demodulation reference signal positions are defined as (l₀, 12) for dmrs-AdditionalPosition=‘pos1’ when the physical downlink shared channel is scheduled such that D=14.

Example 64 includes the non-transitory computer-readable storage medium according to any one of examples 52 to 63 and/or some other examples herein, wherein, irrespective of the mobile radio communication terminal device being configured with lte-CRS-ToMatchAround via higher layers of the open systems interconnection model, demodulation reference signal positions for additional demodulation reference signal symbols are applied in unicast and/or broadcast physical downlink shared channel.

Example 65 includes the non-transitory computer-readable storage medium according to any one of examples 52 to 64 and/or some other examples herein, wherein the mapping to symbol #12 or #8 are applied only when the mobile radio communication terminal device is configured with lte-CRS-ToMatchAround via higher layers of the open systems interconnection model to unicast physical downlink shared channel,

Example 66 includes the non-transitory computer-readable storage medium according to any one of examples 52 to 65 and/or some other examples herein, wherein unicast physical downlink shared channel is scheduled using physical downlink control channel (PDCCH) with cyclic redundancy check (CRC) scrambled with cell-radio network temporary identifier (C-RNTI), circuit switched-radio network temporary identifier (CS-RNTI), or Modulation and coding scheme-radio network temporary identifier (MCS-C-RNTI).

Example 67 includes the non-transitory computer-readable storage medium according to any one of examples 52 to 66 and/or some other examples herein, wherein the minimum mobile radio communication terminal device processing time value (N1) in orthogonal frequency division multiplexing (OFDM) symbol) is increased by one symbol when the last single-symbol demodulation reference signal location within the physical downlink shared channel is symbol #12 of the slot for physical downlink shared channel mapping type A in case the mobile radio communication terminal device is configured with dmrs-AdditionalPosition≠pos0 in demodulation reference signal-DownlinkConfig in either of dmrs-DownlinkForphysical downlink shared channelMappingTypeA, dmrsDownlinkForphysical downlink shared channel-MappingTypeB or if the high layer parameter of the open systems interconnection model is not configured.

Example 68 includes the non-transitory computer-readable storage medium according to any one of examples 52 to 67 and/or some other examples herein, wherein the minimum mobile radio communication terminal device processing time value (N1) (in OFDM symbols) is increased by one symbol when the second demodulation reference signal location is symbol #12 of the slot for physical downlink shared channel mapping type A in case the mobile radio communication terminal device is configured with dmrs-AdditionalPosition=pos1 in demodulation reference signal-DownlinkConfig in dmrs-DownlinkForphysical downlink shared channelMappingTypeA.

Example 69 includes the non-transitory computer-readable storage medium according to any one of examples 52 to 68 and/or some other examples herein, wherein in case of double-symbol demodulation reference signal the minimum mobile radio communication terminal device processing time value (N1) (in OFDM symbols) is increased by two symbols when the last double-symbol demodulation reference signal location within the physical downlink shared channel is symbol #12 of the slot for physical downlink shared channel mapping type A in case the mobile radio communication terminal device is configured with dmrs-AdditionalPosition≠pos0 in demodulation reference signal-DownlinkConfig in either of dmrs-DownlinkForphysical downlink shared channelMappingTypeA, dmrsDownlinkForphysical downlink shared channel-MappingTypeB or if the high layer parameter is not configured.

Example 70 includes the non-transitory computer-readable storage medium according to any one of examples 52 to 69 and/or some other examples herein, wherein the minimum mobile radio communication terminal device processing time value (N1) (in OFDM symbols) is increased by two symbols when the last double-symbol demodulation reference signal location within the physical downlink shared channel is symbol #12 of the slot for physical downlink shared channel mapping type A in case the mobile radio communication terminal device is configured with dmrs-AdditionalPosition=pos1 in demodulation reference signal-DownlinkConfig in dmrs-DownlinkForphysical downlink shared channelMappingTypeA.

Example 71 includes the non-transitory computer-readable storage medium according to any one of examples 52 to 70 and/or some other examples herein, wherein the physical downlink shared channel mapping type A is scheduled with D=8 or D=9 and the corresponding demodulation reference signal locations are defined for dmrs-AdditionalPosition=‘pos1’ as (l₀, 8), either irrespective of configuration of higher layer parameter lte-CRS-ToMatchAround or when higher layer parameter lte-CRS-ToMatchAround is configured to the mobile radio communication terminal device.

Example 72 includes the non-transitory computer-readable storage medium according to any one of examples 52 to 71 and/or some other examples herein, wherein the physical downlink shared channel subcarrier spacing (SCS) of the scheduled physical downlink shared channel is 15 kHz.

Example 73 includes the non-transitory computer-readable storage medium according to any one of examples 52 to 72 and/or some other examples herein, wherein the demodulation reference signal positions are defined for all SCS for the downlink (DL) bandwidth part (BWP) in which the physical downlink shared channel is scheduled.

Example 74 includes the non-transitory computer-readable storage medium according to any one of examples 52 to 73 and/or some other examples herein, wherein the last demodulation reference signal symbol within the physical downlink shared channel duration is delayed.

Example 75 includes the non-transitory computer-readable storage medium according to any one of examples 52 to 74 and/or some other examples herein, wherein symbol delay is applicable when μ=0 to determine the minimum physical downlink shared channel processing time as in Table 5.3-1 of TS38.214.

In Example 76, in addition to any one of the examples 1 to 75, the demodulation reference signal to be transmitted is shifted by a single symbol to avoid transmission on a symbol containing a cell-specific reference signal of LTE as indicated by the first mobile radio communication network to the mobile radio communication terminal device.

Any of the above-described examples may be combined with any other example (or combination of examples), unless explicitly stated otherwise. The foregoing description of one or more implementations provides illustration and description, but is not intended to be exhaustive or to limit the scope of aspects to the precise form disclosed. Modifications and variations are possible in light of the above teachings or may be acquired from practice of various aspects.

In the present disclosure, “SMTC” refers to an SSB-based measurement timing configuration configured by SSB-MeasurementTimingConfiguration;

“SSB” refers to an SS/PBCH block; “field” may refer to individual contents of an information element;

“information element” refers to a structural element containing a single or multiple fields;

a “Primary Cell” refers to the MCG (Master Cell Group) cell, operating on the primary frequency, in which the UE either performs the initial connection establishment procedure or initiates the connection re-establishment procedure;

a “Primary SCG Cell” refers to the SCG cell in which the UE performs random access when performing the Reconfiguration with Sync procedure for DC (Dual Connectivity) operation;

a “Secondary Cell” refers to a cell providing additional radio resources on top of a Special Cell for a UE configured with CA;

a “Secondary Cell Group” refers to the subset of serving cells including the PSCell (Primary SCell) and zero or more secondary cells for a UE configured with DC;

a “Serving Cell” refers to the primary cell for a UE in RRC CONNECTED not configured with CA/DC there is only one serving cell including of the primary cell;

a “serving cell” or “serving cells” refers to the set of cells including the Special Cell(s) and all secondary cells for a UE in RRC CONNECTED configured with CA/DC; and

a “Special Cell” refers to the PCell of the MCG or the PSCell of the SCG for DC operation; otherwise, the term “Special Cell” refers to the PCell.

While the invention has been particularly shown and described with reference to specific aspects, it should be understood by those skilled in the art that various changes in form and detail may be made therein without departing from the spirit and scope of the invention as defined by the appended claims. The scope of the invention is thus indicated by the appended claims and all changes which come within the meaning and range of equivalency of the claims are therefore intended to be embraced.

1.-22. (canceled)

23. A mobile radio communication terminal device comprising:
at least one receiver configured to receive a physical downlink shared channel and an associated physical downlink shared channel demodulation reference signal to be transmitted from a first mobile radio communication network according to an amended scheduling with at least one symbol of the physical downlink shared channel demodulation reference signal being shifted with respect to a scheduling of a cell-specific reference signal in case the mobile radio communication terminal device is operated during coinciding communications of the first mobile radio communication network and a second mobile radio communication network, wherein the second mobile radio communication network is configured to transmit the cell-specific reference signal;
a memory to store the physical downlink shared channel demodulation reference signal of the first mobile radio communication network; and
one or more processors to process the received physical downlink shared channel using the physical downlink shared channel demodulation reference signal transmitted from the first mobile radio communication network in order to provide a hybrid automatic repeat request acknowledgement feedback in response to the physical downlink shared channel if a corresponding minimum mobile radio communication terminal device processing time for physical downlink shared channel processing is satisfied.

24. The mobile radio communication terminal device according to claim 23,
wherein the mobile radio communication terminal device is a user equipment (UE).

25. The mobile radio communication terminal device according to claim 23,
wherein the first mobile radio communication network is a 5G communication network.

26. The mobile radio communication terminal device according to claim 23,
wherein the second mobile radio communication network is a long term evolution (LTE) communication network.

27. The mobile radio communication terminal device according to claim 23,
wherein the physical downlink shared channel demodulation reference signal position for at least one additional demodulation reference signal symbol is shifted by a single symbol to avoid transmission on a symbol containing a cell-specific reference signal of the second mobile radio communication network as indicated by the first mobile radio communication network.

28. The mobile radio communication terminal device according to claim 27,
wherein the minimum second mobile radio communication network processing time for physical downlink shared channel processing is increased by one symbol compared to the case wherein the additional demodulation reference signal symbol of the physical downlink shared channel is not shifted.

29. The mobile radio communication terminal device according to claim 23,
wherein the physical downlink shared channel demodulation reference signal is a physical downlink shared channel demodulation reference signal of a 5G communication network.

30. The mobile radio communication terminal device according to claim 23,
wherein the cell-specific reference signal is a cell-specific reference signal (CRS) of a long term evolution (LTE) communication network.

31. A mobile radio communication device comprising:
one or more processors to generate a physical downlink shared channel and an associated physical downlink shared channel demodulation reference signal according to an amended scheduling with at least one symbol of the physical downlink shared channel demodulation reference signal being shifted with respect to a scheduling of a cell-specific reference signal in case the mobile radio communication device is operated during coinciding communications of a first mobile radio communication network and a second mobile radio communication network, wherein the second mobile radio communication network is configured to transmit the cell-specific reference signal;
at least one transmitter to transmit the physical downlink shared channel and the physical downlink shared channel demodulation reference signal in accordance with the amended scheduling; and
one or more processors configured to indicate resources for hybrid automatic repeat request acknowledgement feedback corresponding to the transmitted physical downlink shared channel according to the amended scheduling to satisfy a corresponding minimum mobile radio communication terminal device processing time for physical downlink shared channel processing.

32. The mobile radio communication device according to claim 31,
wherein the mobile radio communication device is a base station or a core network component.

33. The mobile radio communication device according to claim 31,
wherein the first mobile radio communication network is a 5G communication network and the physical downlink shared channel demodulation reference signal is a demodulation reference signal of the 5G communication network.

34. The mobile radio communication device according to claim 31,
wherein the second mobile radio communication network is a long term evolution (LTE) communication network and the cell-specific reference signal is a cell-specific reference signal (CRS) of the LTE communication network.

35. The mobile radio communication device according to claim 31,
wherein, in the physical downlink shared channel, the physical downlink shared channel demodulation reference signal to be transmitted is shifted by a single symbol to avoid transmission on a symbol containing a cell-specific reference signal of the second mobile radio communication network as indicated by the first mobile radio communication network.

36. The mobile radio communication device according to claim 35,
wherein the minimum mobile radio communication terminal device processing time for physical downlink shared channel processing is increased by one symbol compared to a case wherein an additional demodulation reference signal symbol of the physical downlink shared channel is not shifted.

37. A non-transitory computer-readable storage medium storing program instructions, the program instructions, when executed by one or more processors of a mobile radio communication terminal device, enables the mobile radio communication terminal device to:
receive a physical downlink shared channel and an associated physical downlink shared channel demodulation reference signal from a first mobile radio communication network according to an amended scheduling with at least one symbol of the physical downlink shared channel demodulation reference signal being shifted with respect to a scheduling of a cell-specific reference signal in case the mobile radio communication terminal device is operated during coinciding communications of the first mobile radio communication network and a second mobile radio communication network, wherein the second mobile radio communication network is configured to transmit the cell-specific reference signal; and
store the physical downlink shared channel demodulation reference signal of the first mobile radio communication network.

38. The non-transitory computer-readable storage medium according to claim 37,
wherein the mobile radio communication terminal device is a user equipment (UE).

39. The non-transitory computer-readable storage medium according to claim 37,
wherein the first mobile radio communication network is a 5G communication network and the physical downlink shared channel demodulation reference signal is a physical downlink shared channel demodulation reference signal of the 5G communication network.

40. The non-transitory computer-readable storage medium according to claim 37,
wherein the second mobile radio communication network is a long term evolution (LTE) communication network and the cell-specific reference signal is a cell-specific reference signal (CRS) of the LTE communication network.

41. The non-transitory computer-readable storage medium according to claim 37,
wherein the physical downlink shared channel demodulation reference signal position for at least one additional demodulation reference signal symbol is shifted by a single symbol to avoid transmission on a symbol containing a cell-specific reference signal of the second mobile radio communication network as indicated by the first mobile radio communication network.

42. The non-transitory computer-readable storage medium according to claim 41,
wherein the minimum second mobile radio communication network processing time for physical downlink shared channel processing is increased by one symbol compared to the case wherein the additional demodulation reference signal symbol of the physical downlink shared channel is not shifted.
